(19) United States
(12) Patent Application Publication
(10) Pub. No.: US 2005/0247898 A1
(43) Pub. Date: Nov. 10, 2005

(54) Radiation image reading device

(75) Inventor: Hisashi Yonekawa, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA HOLDING INC., Tokyo (JP)

(21) Appl. No.: 10/524,254

(22) PCT Filed: Aug. 14, 2003
(86) PCT No.: PCT/JP03/10300

§ 371 Date: Feb. 10, 2005

(30) Foreign Application Priority Data
Aug. 16, 2002 (JP) 2002-237702

(51) Int. Cl. G03B 42/08

(52) U.S. Cl. 250/589

(57) ABSTRACT

A radiographic image reading system includes a cassette to record radiographic image information on a recording medium, the recording medium having a front member, and a back member. An apparatus to read out the radiographic image information includes an insertion section, a conveying section, a separation section to separate the back member from the front member, a holding section to hold the back member and the recording medium, a scanning section to read out the information, a peeling off section to peel off the back member and the recording medium, and a combination section to combine the separated front member with the back member and the recording medium again, wherein the peeling off section performs the peeling off after combining the front and back members again. A detection section is provided to detect misholding of the back member or the recording medium, and a control section is provided to control the apparatus to prevent damage of the apparatus and the cassette.

### FIELD OF THE INVENTION

The present invention relates to a radiographic image reading apparatus for reading radiographic image information accumulated in a photostimulable phosphor sheet.

### BACKGROUND ART

For digitizing radiographic image information to be generated in a hospital to save and transmit the information, the chances of using a radiographic image reading apparatus for outputting image information as digital data has been increasing. As such a radiographic image reading apparatus for outputting digital data, a radiographic image reading apparatus using a photostimulable phosphor sheet is well known.

At the moment when a photostimulable phosphor sheet detects a part of radiation energy (image information) having penetrated a subject, the photostimulable phosphor sheet can accumulate the detected radiation energy (image information) therein. The radiation energy (image information) accumulated in the photostimulable phosphor sheet can be taken out as photo-stimulated light by being excited by a laser beam having a predetermined wavelength. The taken out photo-stimulated light is converted to an electric signal by means of a photoelectric conversion element such as a photomultiplier, and then the analog to digital (A/D) conversion of the converted electric signal is performed. Furthermore, signal processing such as uneven correction is performed to the converted signal, and then the processed data is output to a host computer or the like as image data. As described above, the operation of reading image data from a photostimulable phosphor sheet is called as a read operation.

On the other hand, because radiation energy (image information) remains in the photostimulable phosphor sheet after the read operation, erase light is irradiated by an erase lamp such as a halogen lamp and a fluorescent lamp to erase the remaining radiation energy (image information). The operation of erasing the radiation energy (image information) remaining in the photostimulable phosphor sheet as described above is called as an erase operation.

In addition to the case where the erase operation is implemented after a read operation, there is the case where only the erase operation is implemented without performing the read operation.

For example, when radiography has been mistaken, no image information is required, and accordingly only the erase operation is frequently implemented for preparing the next radiography. Moreover, even if erasing is once performed, the photostimulable phosphor accumulates the energy having nothing to do with image information owing to self fog. Consequently, it is expected to use the photostimulable phosphor after performing erasing once before radiography or after the lapse of a predetermined time after erasing. For example, a photostimulable phosphor sheet is used after all of the photostimulable phosphor sheets have been erased every morning. Also in this case, only an erase operation may be implemented without performing any read operation.

However, in the case where a read operation and an erase operation are intermingled, the switching between a read mode and an erase mode is troublesome, and consequently the operating efficiency of an erase operation is lowered.

For example, because an erase mode must be selected every time when erasing is continuously performed, the operating efficiency is lowered.

Moreover, in an apparatus capable of performing continuous erasing, an accident in which, because a previous user did not restore the apparatus to its read mode after the user had operated the apparatus in its erase mode, the next user loses image information by mistake is generated.

Moreover, there is a problem in which, because the main body of an apparatus has no means for notifying a user of the progress of a read operation, the user cannot know the progress of processing and also cannot know the time until the completion of the processing.

Moreover, in case of an apparatus as the radiation reading apparatus of the present invention, which takes a cassette into the inside of the apparatus and performs the separation operation and the combination operation of its front panel and a back panel, and which includes an operation of delivering the back panel to its sub-scanning section, an error in which the back panel cannot be successfully delivered and the back panel falls down into the apparatus, is sometimes generated. When the next cassette is taken to the inside of the apparatus and a series of operations is begun while the back panel is left in the whole apparatus, a problem in which not only the back panel having fallen in the apparatus is destroyed, but also the mechanism of the apparatus is also damaged is caused.

### DISCLOSURE OF THE INVENTION

For solving the problems and for achieving objects, the present invention is configured as follows.

In accordance of a first aspect of the present invention, the radiographic image reading apparatus to read a radiographic image information from a photostimulable phosphor sheet contained in a cassette,
wherein the apparatus performs at least two modes of a read mode to read a radiographic image information held by a photostimulable phosphor sheet, and an erase mode to erase the radiographic image information held by the photostimulable phosphor sheet, and a main body of the radiographic image reading apparatus comprises a switching section to switch at least the two modes.

According to the first aspect of the present invention, a radiographic image reading apparatus includes at least two modes of a read mode and an erase mode, and the radiographic image reading apparatus is configured to be provided with a switching section for switching at least two modes in the main body of the radiographic image reading apparatus. Consequently, a user can select a necessary mode in a short time, and operating efficiency is improved.

Preferably, the read mode performs at least two operations of a read operation to read the radiographic image information from the photostimulable phosphor sheet, and an erase operation to erase the radiographic image information remaining on the photostimulable phosphor sheet after the read operation.

Because the read mode is configured to perform at least two operations of a read operation and an erase operation, there is no necessity of implementing the erase mode after the read mode, and the operating efficiency of a user is improved.

Preferably, the erase mode performs an erase operation to erase the radiographic image information from the photostimulable phosphor sheet.

Because the erase mode is configured to be a mode for performing only the erase operation independently, the radiographic image reading apparatus can erase a radiographic image radiographed by mistake without reading the image, and the operating efficiency of a user is improved.

Preferably, the read mode is automatically selected at time of starting the radiographic image reading apparatus, and the erase mode and the read mode are alternately selected by operating the switching section.

Because the read mode, which is most frequently used, is automatically selected at the time of starting, the apparatus can be used in being unconscious of the erase mode normally. Moreover, because the switching section for switching modes which can alternately select the erase mode and the read mode, the two modes can be selected by a simple operation, and the operating efficiency of a user is improved.

Preferably, in a case where the erase mode is selected, when the cassette is supplied to the radiographic image reading apparatus within a predetermined time, the erase operation is performed, and when the cassette is not supplied to the radiographic image reading apparatus within the predetermined time, the erase mode automatically ends to restore to the read mode.

The radiographic image reading apparatus is configured as follows. That is, when the erase mode is selected, supplying a cassette into the radiographic image reading apparatus in a predetermined time causes the execution of an erase operation, and unsupplying the cassette into the radiographic image reading apparatus in a predetermined time automatically causes the end of the erase mode and the restoration of the apparatus to the read mode. Consequently, the risk of erasing a photostimulable phosphor sheet which is wanted to be read out by mistake after the end of an erase operation is removed.

Preferably, in the erase mode, when the cassette is supplied to the radiographic image reading apparatus within a predetermined time after the erase operation was completed, the erase operation is continuously implemented, and when the cassette is not supplied to the radiographic image reading apparatus within the predetermined time, the erase mode automatically ends to restore to the read mode.

The radiographic image reading apparatus is configured as follows. That is, when a cassette is supplied into the radiographic image reading apparatus in a predetermined time after the completion of an erase operation in the erase mode, an erase operation is continuously implemented. When no cassettes are supplied into the radiographic image reading apparatus in a predetermined time, the erase mode is automatically terminated and the apparatus is restored to the read mode. Consequently, in the cases in which a plurality of sheets is wanted to be erased, the trouble of entering the erase mode again at every time is saved, and the operating efficiency of a user is improved. Moreover, because the apparatus is automatically restored to the read mode when the erase operation has ended, the risk of erasing a photostimulable phosphor sheet which is wanted to be read out by mistake after the erase operation is removed.

Preferably, the apparatus further comprises a display section to display the predetermined time.

Because display section for displaying the predetermined time is provided, a waiting time for continuous erasing can be confirmed, and a user can perform the erase operation without anxiety.

Preferably, a residual time of the predetermined time displayed on the display section is displayed by down count or up count.

Because the residual time of the predetermined time is displayed in the form of down count or up count, there is no necessity for minding residual time, and a user can perform an erase operation without anxiety.

Preferably, the erase mode comprises a plurality of erase operations having erase speeds different from each other, and the plurality of erase operations is selected by operating the switching section.

Because the erase mode includes a plurality of erase operations having different erase speeds and the switching of the plurality of erase operations can be operated by the switching section for switching the read mode and the erase mode, a user can easily select a favorite erase speed with a few operations, and the operating efficiency of the user is improved.

Preferably, an operation of switching from the read mode to the erase mode is accompanied by a long-time pushing operation of a button or a switch.

Because the radiographic image reading apparatus is configured so that a switching operation from the read mode to the erase mode includes a long-time pushing operation of a button or a switch, an accident of losing image information by entering into the erase mode by mistake during performing reading can be prevented.

Preferably, the apparatus further comprises a display section to display a progress of a processing when the cassette is processed.

Because the radiographic image reading apparatus is configured to include a display section for displaying the progress of processing when a cassette is processed, an operator can roughly estimate a time until the completion of the processing, and consequently the operating efficiency of a user can be improved.

Preferably, the progress of the processing displayed on the display section is updated according to a lapse of a predetermined processing unit.

Because the radiographic image reading apparatus is configured so that the progress of the processing displayed on the display section is updated at every lapse of a predetermined processing unit, the outline of the processing which a user is performing at the present time during processing can be known, which is very convenient.

Preferably, the predetermined processing unit when the cassette is processed in the read mode comprises at least two kinds of processing of the read operation and the erase operation.

The radiographic image reading apparatus is configured as follows. That is, when a cassette is processed in the read mode, the progress of the processing displayed on the display section is updated at every lapse of the predetermined processing unit. Furthermore, the predetermined processing unit includes at least two pieces of processing of the read operation and the erase operation. Consequently, a user can recognize the most important read operation and erase operation in each processing, which is very useful for grasping the progress of processing.

Preferably, the progress of the processing displayed on the display section is presented by sequentially altering a display color of a plurality of display elements displayed on the display section in advance.

Because the radiographic image reading apparatus is configured to present the progress of the processing displayed on the display section by altering display colors of a plurality of display elements displayed on the display section in advance sequentially, a user can recognize which phase the present processing is located at in the whole processing time.

In accordance with a second aspect of the present invention, the radiographic image reading apparatus to read a radiographic image information from a photostimulable phosphor sheet attached to a back panel side of a cassette in which a front panel and a back panel can be separated from each other, comprises:
an insertion opening to insert a cassette;
a conveying section to move the cassette;
a separation section to separate the front panel and the back panel of the cassette;
a sub-scanning section to perform a sub-scanning of the back panel separated from the front panel by the separation section;
a reading section to read a radiographic image information held by the photostimulable phosphor sheet attached to the back panel;
a combination section to combine the front panel with the back panel again;
an ejection port to eject the cassette combined by the combination section; and
a sensor to detect a fall of the back panel,
wherein when the fall of the back panel is detected by the sensor, the fall is dealt with as an error.

According to the second aspect of the present invention, because a disadvantage in which the back panel falls in the apparatus is detected to be treated as an error, it becomes possible to control the apparatus not to operate even when the next cassette is inserted. Consequently, the back panel having fallen in the apparatus is not destroyed, and also the mechanism of the apparatus is not damaged. Thereby, the reliability of the apparatus is improved.

Preferably, the sensor to detect the fall of the back panel is a back panel absorption sensor outputting on when the back panel is absorbed by the sub-scanning section, and considers that the back panel fell when the back panel absorption sensor outputs off in a time zone in which the back panel absorption sensor should be on.

Because the back panel absorption sensor outputting on when the back panel is absorbed by the sub-scanning section is included, the back panel can be regarded as being fallen and can be treated as an error when the back panel absorption sensor outputs off in a time zone in which the back panel absorption sensor should be on.

Preferably, the sensor to detect the fall of the back panel is a back panel fall detection sensor to detect an existence or a nonexistence of the back panel when the cassette is ejected to the ejection port, and considers that the back panel fell when the back panel fall detection sensor outputs a signal indicating the nonexistence of the back panel at time of ejection of the cassette.

Because the radiographic image reading apparatus includes the back panel fall detection sensor for detecting existence or nonexistence of the back panel when the cassette is ejected to an ejection port, and the apparatus cassette performs the control thereof on the supposition that the back panel has fallen when the back panel fall detection sensor outputs a signal value indicating the nonexistence of the back panel at the time of the ejection of the cassette, and whether the back panel has fallen in the apparatus or not can be recognized after the ejection of the cassette. Thereby, the back panel having fallen in the apparatus is not destroyed and the mechanism of the apparatus is not damaged. Therefore, the reliability of the apparatus is improved.

Preferably, the back panel fall detection sensor is configured to detect the existence or the nonexistence of the back panel by detecting an inclination of a tracing rod tracing the back panel side of the cassette.

Because the radiographic image reading apparatus is configured to detect existence or nonexistence of the back panel by detecting the inclination of a tracing rod tracing the side of the back panel of the cassette with the back panel fall detection sensor, existence or nonexistence of the back panel can be accurately detected.

In accordance with a third aspect of the present invention, the radiographic image reading apparatus to read a radiographic image information from a photostimulable phosphor sheet attached to a back panel side of a cassette in which a front panel and a back panel can be separated from each other, comprises:
a separation section to separate the front panel and the back panel of a cassette;
a sub-scanning section to perform a sub-scanning of the back panel separated from the front panel by the separation section, in a state of absorbing the back panel; and
a back panel absorption sensor to detect that the back panel is absorbed to the sub-scanning section,
wherein when the back panel absorption sensor outputs off in a time zone in which the back panel absorption sensor should be on, the output is considered to be an error and is dealt with as the error.

According to the third aspect of the present invention, because the radiographic image reading apparatus includes the back panel absorption sensor outputting ON when the back panel is absorbed by the sub-scanning section, it can be regarded as the falling of the back panel to perform the dealing as an error that the back panel absorption sensor output OFF in a time zone in which the back panel absorption sensor should be ON.

In accordance with a fourth aspect of the present invention, the radiographic image reading apparatus to read a radiographic image information from a photostimulable phosphor sheet attached to a back panel side of a cassette in which a front panel and a back panel can be separated from each other, comprises:
an insertion opening to insert a cassette;
an ejection port to eject the cassette; and
a back panel fall detection sensor to detect an existence or a nonexistence of the back panel,
wherein when the back panel fall detection sensor outputs a signal indicating the nonexistence of the back panel, the back panel is considered to have fallen, and the apparatus is controlled not to operate even when a next cassette is inserted into the insertion opening.

According to the fourth aspect of the present invention, the radiographic image reading apparatus includes a back panel fall detection sensor for detecting existence or nonexistence of the back panel, and the apparatus regards the situation as the falling of the back panel when the back panel fall detection sensor outputs the signal indicating the nonexistence of the back panel, and further the apparatus controls itself not to operate even when the next cassette is inserted into the insertion opening. Consequently, it is not generated to destroy the back panel owing to the apparatus' operation in spite of the falling of the back panel into the apparatus, or to damage the mechanism of the apparatus. Thereby, the reliability of the apparatus is improved.

Preferably, the back panel fall detection sensor is configured to detect the existence or the nonexistence of the back panel when the cassette is ejected into the ejection port.

Because the radiographic image reading apparatus is configured to perform the detection of existence or nonexistence of the back panel by the back panel fall detection sensor at the time of the ejection of the cassette to the ejection port, whether the back panel has fallen into the inside of the apparatus or not can be recognized after the ejection of the cassette. In the case where the back panel has fallen into the inside of the apparatus, it becomes possible to control the apparatus not to operate even if the next cassette is inserted. Consequently, it is not generated to destroy the back panel having fallen in the apparatus, or to damage the mechanism of the apparatus. Thereby, the reliability of the apparatus is improved.

Preferably, the back panel fall detection sensor is configured to detect the existence or the nonexistence of the back panel by detecting an inclination of a tracing rod tracing the back panel side of the cassette.

Because the radiographic image reading apparatus is configured such that the back panel fall detection sensor detects the inclination of the tracing rod tracing the side of the back panel of the cassette to detect the existence or the nonexistence of the back panel, the existence or the nonexistence of the back panel can be accurately detected.

### BRIEF DESCRIPTION OF THE DRAWINGS

FIGS. 1A and 1B are perspective views when the front panel and the back panel of a cassette are separated;

FIG. 2 is a sectional view when the front panel and the back panel of the cassette are combined;

FIGS. 3A, 3B, 3C, 3D, 3E, 3F, 3G and 3H are views showing the locked state of the back panel and the front panel;

FIGS. 4A and 4B are views showing a locking mechanism of the back panel and the front panel;

FIGS. 5A and 5B are views of the back panel of the cassette when it is looked from the back side thereof;

FIG. 6 is a view showing an example of the configuration of a radiographic image reading apparatus;

FIG. 7 is a view showing the relation between a conveying section and a sub-scanning section;

FIG. 8 is view of cassette insertion and ejection portion when it is looked from above;

FIG. 9 is a view of a display and operation portion when it is looked from the front thereof;

FIGS. 10A and 10B are views showing the relation between the conveying section and the sub-scanning section at the time of the delivery of the back panel;

FIG. 11 is a view showing positional relations of a cassette by an upper side reference and a center reference; and

FIG. 12 is a transition diagram showing changes of display contents by a display section.

### BEST MODE FOR CARRYING OUT THE INVENTION

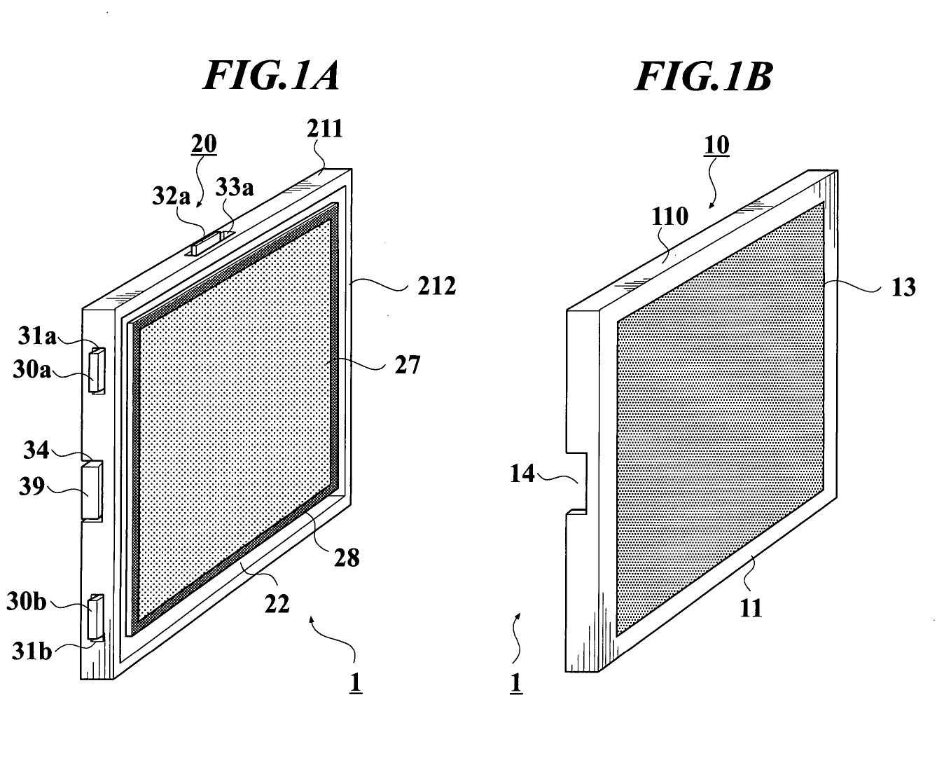

In the following, an example of the embodiments of the present invention is described with reference to the attached draw outings. FIGS. 1A-5B are views showing a cassette 1 used in a radiographic image reading apparatus of the present invention.

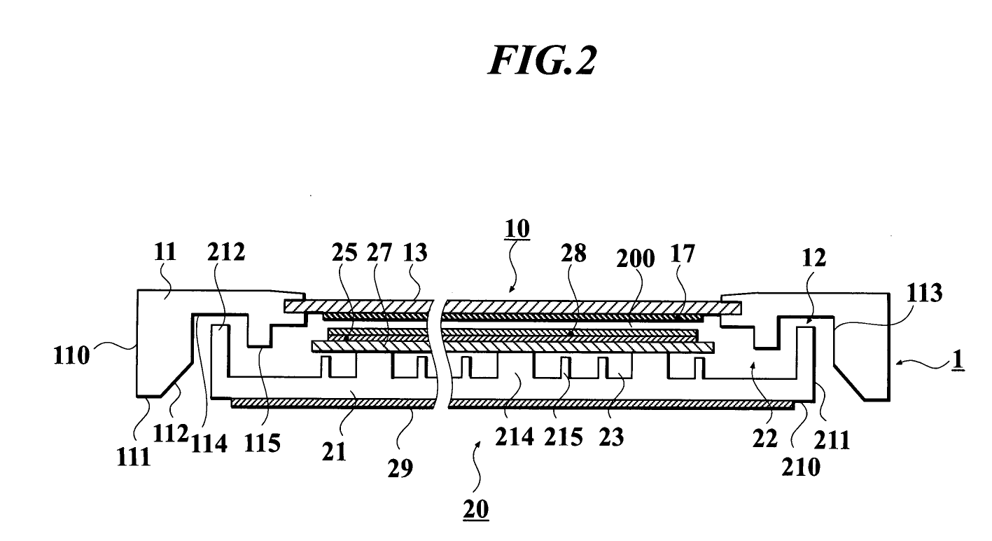

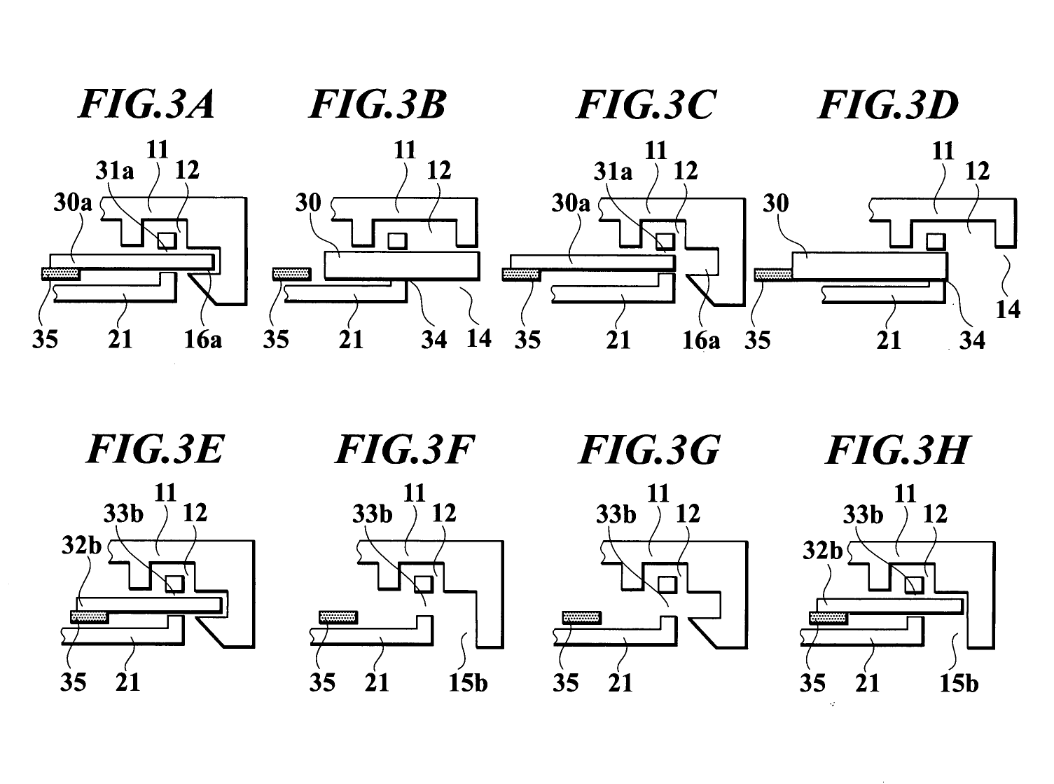

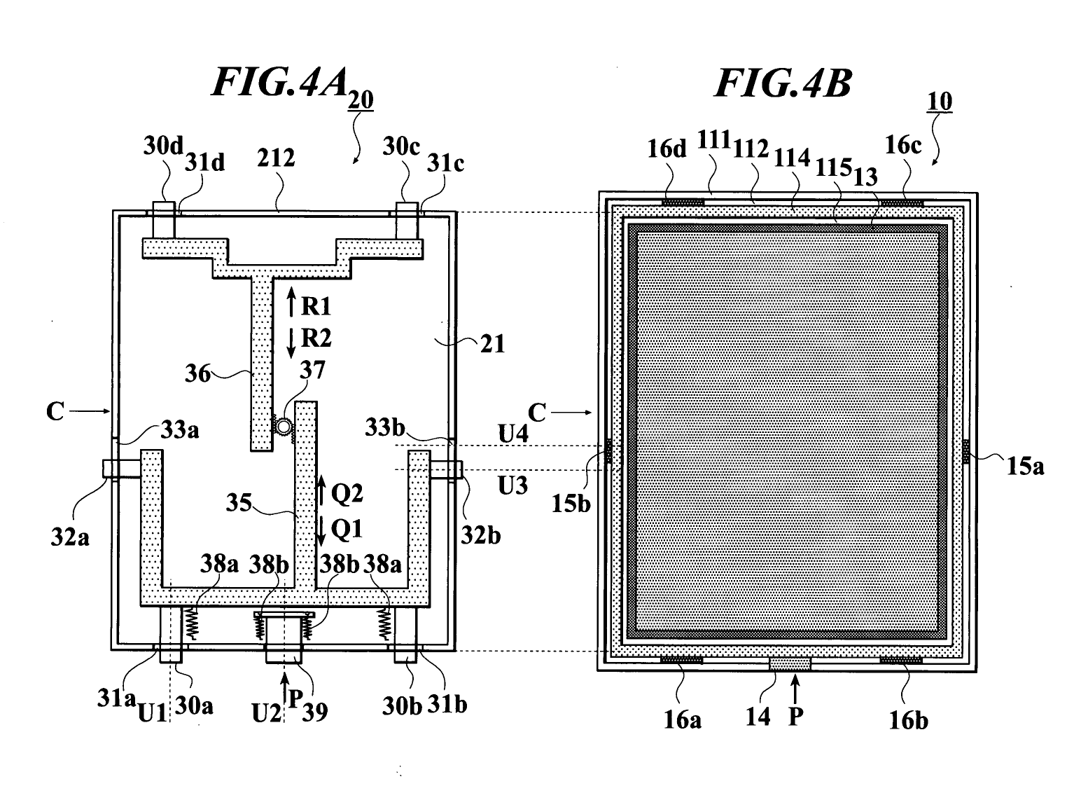

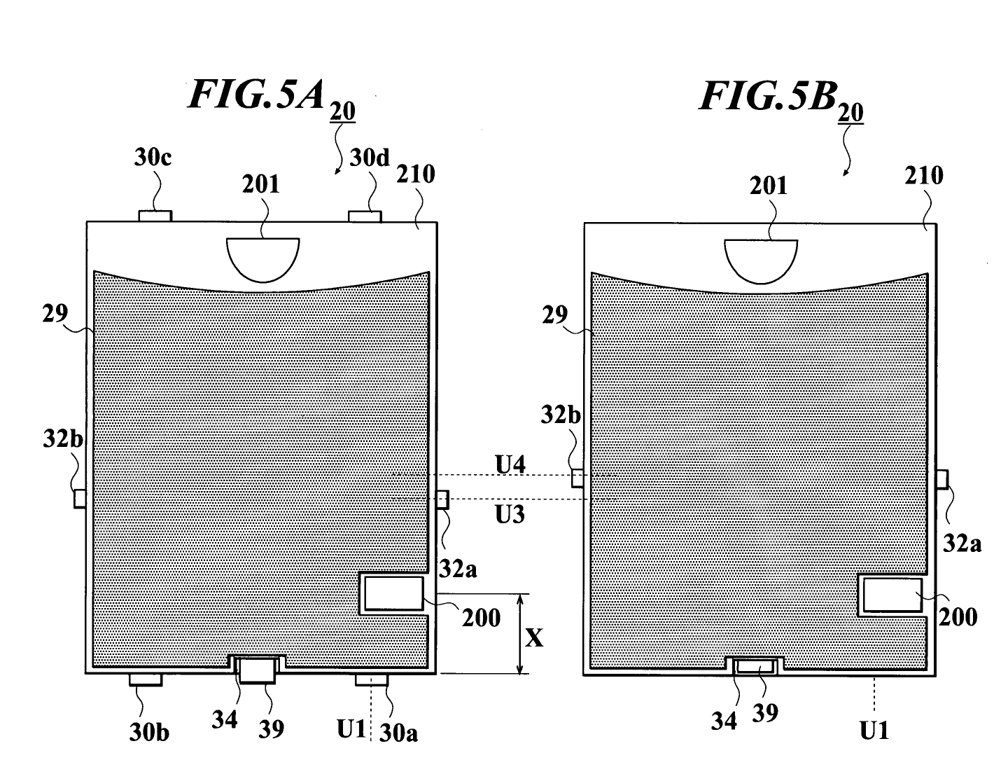

The cassette 1 comprises a front panel 10 and a back panel 20, which can be separated from each other. FIGS. 1A and 1B are perspective views when the front panel 10 and the back panel 20 of the cassette 1 are separated from each other. FIG. 2 is a sectional view when the front panel 10 and the back panel 20 of the cassette 1 are combined. FIGS. 3A-3H are sectional views of the cassette 1 showing states of a locking mechanism. FIGS. 4A and 4B are views illustrating the locking mechanism of the cassette 1. FIGS. 5A and 5B are views of the back panel 20 when it is looked from the back side (the opposite side to the front panel 10).

The front panel 10 comprises a frame 11 and a front face panel 13. A non-woven fabric 17 is stuck on the inner face of the front face panel 13. The frame 11 comprises a frame side face 110, a frame bottom face 111, an inclined face 112 and an inward face 113, which form an inclination of a predetermined angle, a frame inner face 114, a shielding projection 115, an insertion hole 14, notches 15a and 15b, and locking recesses 16a, 16b, 16c and 16d. The inclined face 112, the frame inner face 114 and the shielding projection 115 form a recess 12 in the frame 11.

By forming the inclined face 112 in the frame 11 like this, it becomes possible to design the accuracy of alignment roughly at the time of the combination of the back panel 20 with the front panel 10. That is, by forming the inclined face 112 in the frame 11, the inclined face 112 automatically guides the back panel 20 to the combination location even if the location at the combination of the back panel 20 with the front panel 10 is somewhat shifted. Consequently, it is possible to set the requirement to the accuracy of parts and the accuracy of assembly on the side of the apparatus to be loose. Moreover, even if a delicate deformation is generated in the framework or the mechanism of the apparatus at the time of the transportation of the apparatus, the probability of causing a defect at the time of the combination operation of the front panel 10 with the back panel 20 can be made to be very small.

It is preferable that the frame 11 is made of a material, such as aluminum and a rigid plastic, which can withstand a large weight at the time of all weight radiography. It is preferable that the front face panel 13 is made of a member, such as aluminum and a carbon fiber reinforced plastic, which has strong strength and relatively little absorption of radiations.

In a cassette of the type of opening and closing the side face side of the cassette or of drawing out the side face plate of the cassette, the circumference of the side face of the cassette cannot be constituted in a structure having no cut lines. Consequently, the structure is one which is weak against a load from the front side. On the other hand, in the present embodiment, because the structure thereof is the one in which the frame 11 of the front panel 10 covers the circumference of the front face panel 13 without no cut lines, the load from the side of the front panel 10 of the cassette 1 during radiography can be uniformly received by the whole frame 11. Consequently, the embodiment has the very strong structure to the load from the side of the front panel 10.

The back panel 20 is formed of a back panel main body 21, an X-ray absorbing sheet 25, a supporting plate 27 and a photostimulable phosphor sheet 28.

The photostimulable phosphor sheet 28 sticks to the supporting plate 27 with the X-ray absorbing sheet 25 put between them. The supporting plate 27 sticks to the surface of adhesion portions 214 with double faced adhesive tapes, adhesives or the like at strength at which the plate 27 can be replaced. The X-ray absorbing sheet 25 is, for example, a lead sheet, and absorbs an X-ray penetrated the photostimulable phosphor sheet 28. The sheet 25 fills the role of preventing the arrival of the following back scattered radiations to the photostimulable phosphor sheet 28: the back scattered radiations from structures of the cassette 1 such as the supporting body 27 and the back panel main body 21, which are located behind the photostimulable phosphor sheet 28, and the back scattered radiations from the other structures which may exist further behind the cassette 1. The adhesion portions 214 and ribs 215 form an air phase 23, and contribute the lightening of the cassette. In such a way, the photostimulable phosphor sheet 28 having the supporting plate 27 forms an integral structure in a form capable of being torn from the back panel main body 21.

When the photostimulable phosphor sheet 28 is wanted to be exchanged, the whole supporting plate 27 is torn from the adhesion portions 214, and after that the supporting plate 27 to which a new photostimulable phosphor sheet 28 is attached may be stuck to the adhesion portions 214 with double faced adhesive tapes, adhesives or the like. In the case where the double faced adhesive tapes are used for the sticking of the supporting plate 27 with the adhesion portions 214, it is preferable to stick the double faced adhesive tapes to adhesion places with the adhesion portions 214 on the side of the supporting body 27 in advance. In the case where the double faced adhesive tapes are stuck to the side of the supporting body 27 beforehand, when the supporting plate 27 is torn from the back panel main body 21, the double faced adhesive tapes do not remain on the side of the adhesion portions 214 of the back panel main body 21, and the tapes are torn off together with the supporting plate 27 of the photostimulable phosphor sheet 28. Consequently, the cleaning processing (the processing of cleaning the wrecks of the previous double faced adhesive tapes) on the adhesion surfaces of the adhesion portions 214 becomes easy at the time of pasting the next photostimulable phosphor sheet 28.

Moreover, for making the exchange of the photostimulable phosphor sheet 28 easy, the supporting plate 27 may be configured to be absorbed to the adhesion portions 214 by magnetic force instead of sticking the supporting plate 27 to the adhesion portions 214 with the double faced adhesive tapes, the adhesives, or the like. For example, magnets are stuck on parts (the adhesion surfaces of the adhesion portions 214) of the back surface (the surface on which the photostimulable phosphor sheet 28 is not stuck) of the supporting plate 27, and on the other hand, the adhesion portions 214 or the surfaces of the adhesion portions 214 are formed of a material of magnetic substance. By adopting such a configuration, the supporting plate 27, on which the photostimulable phosphor sheet 28 is stuck, can be easily taken out from the back panel 20. Moreover, it is needless to say that similar effects can be obtained by disposing the magnetic substances on parts (adhesion surfaces with the adhesion portions 214) of the back face of the supporting plate 27 and by forming the adhesion portions 214 or the surface portions of the adhesion portions 214 to be magnets.

As the supporting plate 27, a resin plate which is light in weight, difficult to deform by changes in temperature and humidity, good in planarity, and thick of about 0.5 mm to 3 mm, such as the resin plates of a glass epoxy resin plate and a paper phenol resin plate, or a carbon fiber reinforced plastic, which is light in weight and strong in strength, can be used. Moreover, as the supporting plate 27, a light metal plate made of aluminum or a magnesium alloy may be used.

In the case where a metal is used as the supporting plate 27, it is preferable to form small holes in the whole surface of the metal for lightening the weight thereof.

The back panel main body 21 comprises a back panel back face 210, a back panel side face 211, a rim 212, the ribs 215, and a magnetic substance sheet 29 made of an iron foil or the like. A recess 22 for accepting the shielding projection 115 is formed in the inside of the rim 212.

When the back panel 20 and the front panel 10 are combined as shown in FIG. 2, the recess 22 works so that the shielding projection 115 of the front panel 10 enters the recess 22 of the back panel 20, and the recess 12 works so that the rim 212 of the back panel 20 enters the recess 12 of the front panel 10. In such a way, light shielding is preformed lest outside light should reach the photostimulable phosphor sheet 28. For example, sticking velvet, sponge or the like to the recess 12 of the front panel 10 could improve the light shielding property.

Moreover, the cassette 1 is designed in order that a certain measure of gap may be produced between the tip of the inclined face 112 of the front panel 10 and the inward face 113 of the frame 11, and the back panel side face 211 in the state in which the front panel 10 and the back panel 20 are combined as shown in FIG. 2. The gap is a gap necessary for performing the combination of the front panel 10 and the back panel 20 smoothly. When the interval of the gap is about 0.2-2 mm, the combination of the front panel 10 and the back panel 20 can be performed sufficiently smoothly. Moreover, the gap is important also in the sense of absorbing the manufacturing errors of the front panel 10 and the back panel 20 and the thermal expansion of the back panel, and the gap improves the reliability and the stability of the combination operation of the front panel 10 and the back panel 20.

In this embodiment, because the light shielding method using the combination of the recesses and the projections as described above is adopted, it is not considered that the outside light entered through the gap reaches the photostimulable phosphor sheet 28 to fog the photostimulable phosphor.

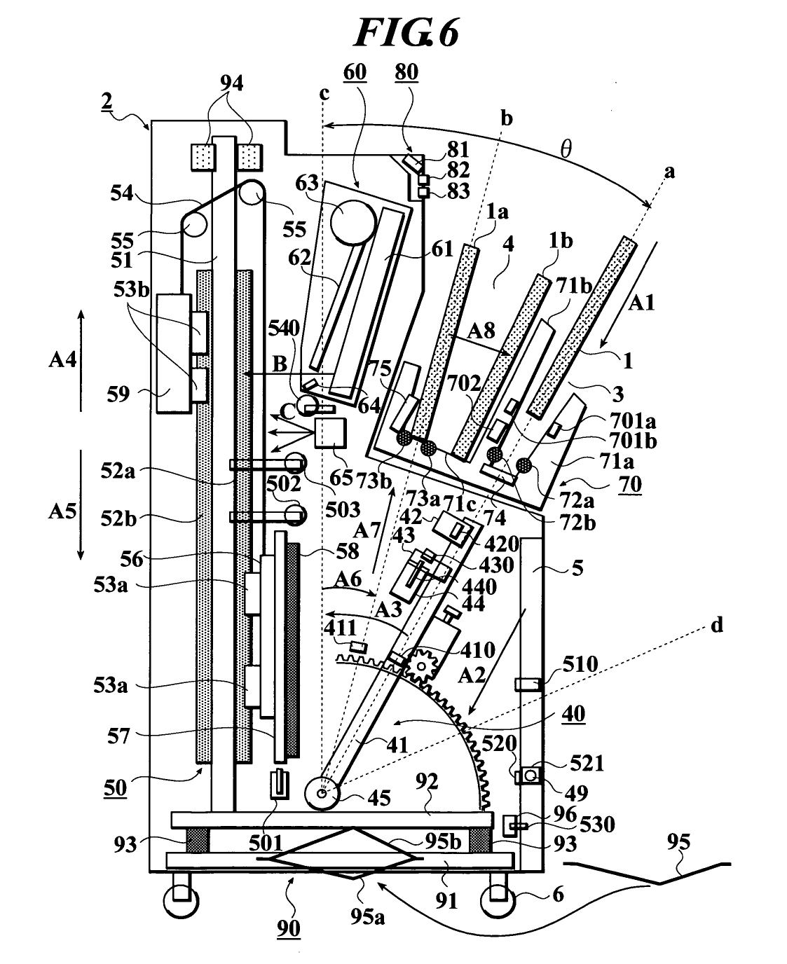

The back panel main body 21 is normally configured to be formed of plastic with the magnetic substance sheet 29 such as the iron foil being stuck to the back panel back face 210 as shown in FIG. 2 in order that the back panel main body 21 can be absorbed to a magnet 58 of FIG. 6 by magnetic force. The surface of the magnetic substance sheet 29 is made to be in a state in which the surface is covered by not shown laminate plastic or is coated by a paint, and then the surface is configured in order not to expose the magnetic substance sheet 29. For example, the back panel main body 21 itself may be formed of magnetic substance plastic instead of sticking the magnetic substance sheet 29. Moreover, a method of coating a magnetic substance material on the back panel back face 210, or the like may be used.

Moreover, the back panel back face 210 is designed in order that the back panel back face 210 follows a plane formed by the magnet 58 at the time of being absorbed by the magnet 58. That is, the back panel 20 has a certain measure of stiffness and flexibility up to the degree at which the back panel 20 can follow the plane formed by the magnet 58. By forming the back panel 20 to have a certain flexibility like this, even if the back panel 20 is deformed or warped owing to, for example, a secular change or the status of use, the deformation and the warp of the back panel 20 are remedied by following the plane on the side of the magnet 58. Consequently, the surface of the photostimulable phosphor sheet 28 can be always kept to be a plane at the time of reading image information.

When radiography with a load being weighted from the side of the front panel 10 (such as bed radiography, full weight load radiography or the like) is performed, the front face panel 13 of the front panel 10 generates a good deal of warp toward the side of the back panel 20. Because the back panel 20 keeps its planarity in the case that its stiffness is too large at this time, the photostimulable phosphor sheet 28 is pressed by both of the front panel 10 and the back panel 20 by a good deal, the photostimulable phosphor is damaged. As described above, when the back panel 20 has both of a certain measure of stiffness and a certain measure of flexibility, the back panel 20 can bend to a certain extent into the direction avoiding from the press of the front panel 10, and consequently the photostimulable phosphor becomes being not damaged.

Of course, the back panel 20 should not have superfluous flexibility. When the back panel 20 has the superfluous flexibility, the durability of the cassette 1 is lowered. Moreover, when the back panel 20 has the superfluous flexibility, the sag amount of the back panel 20 owing to the dead weight of the back panel 20 becomes large. Consequently, a problem is generated with regard to the light shielding property, or a problem is generated with regard to the planarity of the photostimulable phosphor surface at the time of radiography.

Moreover, the ribs 215 are formed on the back panel main body 21 with the object of forming the back panel main body 21 to be light and increasing its flexural strength, and with the object of braking the deformation of the photostimulable phosphor sheet 28 when the photostimulable phosphor sheet 28 is pressed from the side of the front panel 10. Furthermore, the non-woven fabric 17 is disposed on the surface of the front face panel 13 on the side of the photostimulable phosphor sheet 28 in order that the surface of the photostimulable phosphor sheet 28 may not be damaged by contacting with the front face panel 13 when the photostimulable phosphor sheet 28 is pressed from the side of the front panel 10. It is preferable that the non-woven fabric 17 is sized to be smaller than the front face panel 13 and to be larger than the phosphor coated surface of the photostimulable phosphor sheet 28 (to be able to cover the whole phosphor coated surface). In the case where the non-woven fabric 17 is smaller than the phosphor coated surface, the difference of the absorption of X-rays by the non-woven fabric 17 is recorded on the photostimulable phosphor sheet 28 as image information. Consequently, such a situation is not preferable. Moreover, in the case where the non-woven fabric 17 has a texture, the difference of the absorption of X-rays owing to the texture is recorded on the photostimulable phosphor sheet 28 as image information. Therefore, it is preferable to use a non-woven fabric having a texture as little as possible. Moreover, when the non-woven fabric fuzzes, the fibers of the non-woven fabric floats in the apparatus. When the floating fibers adhere to the laser optical system of the apparatus or the like, the laser strength of the apparatus becomes not uniform at the time of reading, and is a cause of the generation of an image defect such as a vertical line on the image. Accordingly, it is preferable to use a non-woven fabric having the fuzz as little as possible as the non-woven fabric 17. Moreover, it is preferable to use a non-woven fabric to which fuss prevention processing is performed by performing the surface treatment processing of the non-woven fabric 17 by making a resin or the like soak into the non-woven fabric 17.

The front panel 10 and the back panel 20 can be separated from each other, but normally radiography or the like is performed in the state of being combined with each other as shown in FIG. 2.

Next, the locking mechanism of the cassette 1 is described referring to FIGS. 3A-3H, 4A and 4B.

A locking mechanism is prepared for the cassette 1 for keeping the front panel 10 and the back panel 20 in their combined state. Reference numerals 30a, 30b, 30c and 30d of the back panel 20 severally denote a locking claw. The locking mechanism is configured to move the tip of each locking claw into the direction of an arrow Q1 or an arrow Q2 from each of opening portions 31a, 31b, 31c and 31d as a locking ON/OFF operation.

Reference numeral 32a and 32b of the back panel 20 denote locking claws different from the locking claws 30a, 30b, 30c and 30d. The locking mechanism is configured to slide the locking claws 32a and 32b in opening portions 33a and 33b, respectively, into the direction of an arrow Q1 or an arrow Q2 as a locking ON/OFF operation.

A lock ON state means a state in which the tips of the locking claws 30a, 30b, 30c and 30d project from the back panel side face 211 to the outside. At this time, each tip of the locking claws 30a, 30b, 30c and 30d is in the state of being plunged into each of the locking recesses 16a, 16b, 16c and 16d of the front panel 10.

The sectional views of the cassette 1 on dotted lines U1 and U2 in FIG. 4A at the time of the lock ON state are shown in FIGS. 3A and 3B, respectively.

In the lock ON state, the tips of the locking claws 32a and 32b are in the state of having moved to the direction of the arrow Q1. At this time, the notches 15a and 15b (openings formed in the frame inward face 113 and the inclined face 112) of the front panel 10 are in the state in which their phases do not accord with those of the locking claws 32a and 32b, namely in the state in which the back panel 20 cannot be separated from the front panel 10. The sectional views of the cassette 1 on dotted lines U3 and U4 of FIGS. 4A and 4B at the time are shown in FIGS. 3E and 3F, respectively.

A lock OFF state means a state in which the tips of the locking claws 30a, 30b, 30c and 30d have entered to the inside of the back panel side face 211. The sectional views of the cassette 1 on the dotted lines U1 and U2 in FIG. 4A at the time are shown in FIGS. 3C and 3D, respectively. In the lock OFF state, because the locking claws 32a and 32b are in the state in which their phases accord with those of the notches 15a and 15b, respectively, the back panel 20 becomes capable of being separated from the front panel 10. The sectional views of the cassette 1 on the dotted lines U3 and U4 in FIGS. 4A and 4B at the time are shown in FIGS. 3G and 3H, respectively.

The locking claws 30a, 30b, 32a and 32b are configured to interlock with a connecting member 35. On the other hand, the locking claws 30c and 30d are configured to interlock with a connecting member 36. End of springs 38a on one side are connected with the connecting member 35, and the other ends of them are connected to the back panel main body 21. By the springs 38a, the connecting member 35 always receives the force to move the member 35 to the direction of the arrow Q1. The insertion hole 14 of the front panel 10 is in a positional relation of corresponding to an insertion hole 34 of the back panel 20 at the time of combination.

At the time of the lock ON state, when a rod member is insert into the direction of an arrow P from the insertion hole 14 (insertion hole 34) only one time to perform pushing, the connecting member 35 stops at the state in which the member 35 has completed the moving to the direction of the arrow Q2 by a predetermined distance, and the locking mechanism is in the lock OFF state shown in FIGS. 3C and 3D.

When the connecting member 35 has moved into the direction of the arrow Q2, a rack and pinion operation is caused by the rack shapes of the tips of the connecting member 35 and the connecting member 36 and a pinion 37, and consequently also the connecting member 36 moves into the direction of an arrow R2 by the same distance to stop. At this time, by interlocking with the connecting member 35, also the locking claws 32a and 32b move into the direction of the arrow Q2 by the same distance to stop, and the locking mechanism is in the lock OFF state shown in FIGS. 3G and 3H.

That is, when the rod member is inserted into the direction of the arrow P from the insertion hole 14 (insertion hole 34) only one time at the time of the lock ON state and performs pushing, the locking mechanism shifts to the lock OFF state and enters the state in which the front panel 10 and the back panel 20 can be separated from each other. The lock OFF state is kept to continue until the rod member is next operated from the insertion hole 14 (insertion hole 34).

When the rod member is inserted from the insertion hole 14 (insertion hole 34) into the direction of the arrow P only one time to perform pushing at the time of the lock OFF state, the connecting member 35 moves into the direction of the arrow Q1 by the predetermined distance to stop in the state, and the locking mechanism shifts to the lock ON state shown in FIGS. 3A and 3B.

When the connecting member 35 has moved into the direction of the arrow Q1, the above-mentioned rack and pinion operation is caused, and also the connecting member 36 moves into the direction of the arrow R1 by the same distance to stop there. At this time, also the locking claws 32a and 32b move into the direction of the arrow Q1 by the same distance, and the locking mechanism enters the lock ON state shown in FIGS. 3E and 3F.

That is, when the rod member is inserted from the insertion hole 14 (insertion hole 34) only one time at the time of the lock OFF state and performs pushing, the locking mechanism shifts to the lock ON state, and enters the state in which the front panel 10 and the back panel 20 cannot be separated from each other. The lock ON state is kept to continue until the rod member is operated next through the insertion hole 14 (insertion hole 34).

As described above, the cassette 1 of the present embodiment adopts the system (push and latch system) in which the lock ON state and the lock OFF state are switched every insertion and pushing of the rod member through the insertion hole 14 (insertion hole 34). The push and latch system is well known as the mechanism used at the time of putting in and out a refill for a ball-point pen from the exterior package of the ball-point pen. The push and latch mechanism is contained in a push and latch portion 39 of FIG. 4A. Ends of springs 38b on one side are connected with the push and latch portion 39, and their other ends are connected with the back panel main body 21. The push and latch portion 39 always receives the force forcing the push and latch portion 39 into the direction of the arrow Q1 by the springs 38b.

The notches 15a and 15b of the front panel 10 and the locking claws 32a and 32b are disposed at a location distant from the center location C (the location indicated by an arrow C) on the side of the side face of the cassette 1 by a predetermined distance. By disposing the notches 15a and 15b and the locking claws 32a and 32b at the location shifted from the center location C on the side of the side face of the cassette 1 (incidentally, in the case where either pair of the pairs of a pair of the locking claw 32a and the notch 15a and a pair of the locking claw 32b and a notch 15b is disposed so as to be shifted from the center location C on the side of the side face of the cassette 1, the other pair may be disposed at the center location C of the side of the side face of the cassette 1), the back panel 20 and the front panel 10 are configured not to be combined with each other except for the case where the directions of the both panels are correct ones. Thereby, for example, when a user separates the cassette 1 and wants to re-combine the cassette 1 after an operation with the object of the cleaning of the inside of the cassette or the replacement of the photostimulable phosphor sheet 28, the risk of combining the back panel 20 and the front panel 10 with each other with their directions being mistaken is avoided.

Such a mechanism for avoiding the risk of combining the back panel 20 and the front panel 10 with their directions being mistaken is called as a reverse entering prevention mechanism.

Moreover, at least one projection is formed on either of the frame 11 of the front panel 10 (for example, the inner face and the inclined face 112 of the frame side face 110, and the like) and the circumference portion of the back panel (for example, the external surface of the back panel side face 211), and at least one recess is formed on the other panel. The projection and the recess are disposed so as to accord with each other only when the front panel 10 and the back panel 20 are opposed to each other in a right direction. Thereby, the reverse entering prevention mechanism can be easily built.

For example, projections having shapes similar to the locking claws 32a and 32b are formed on the external surface of the back panel side face 211, and recesses having shapes similar to the notches 15a and 15b are formed on the frame 11 of the front panel 10. These projections and recesses are disposed in the same positional relations as those of the locking claws 32a and 32b and the notches 15a and 15b in the lock OFF state. Thereby, the reverse entering prevention mechanism can be built.

Moreover, when the locking mechanism is configured only by the locking claws 30a, 30b, 30c and 30d (in the state of lacking the locking claws 32a and 32b), the sides of the back panel 20 which have no locking claws sag vertically downward owing to the dead weight of the back panel 20 when the cassette 1 is held so that the front panel 10 faces vertically upward. In such a way, the locking mechanism by means of the locking claws 32a and 32b can also serve as the mechanism for preventing the sag of the back panel 20 owing to the dead weight (sag prevention mechanism).

Incidentally, for the cassette 1 having a relatively small size in which the sag of the back panel 20 owing to the dead weight is not easily generated, such a sag prevention mechanism is not always necessary.

Moreover, although the insertion hole 14 and the insertion hole 34 are expressed as the shape of a rectangle in the present embodiment, this fact does not mean that the shapes of the insertion hole 14 and the insertion hole 34 are limited to the shapes of rectangles. Fort example, they may have the shapes of circles or the like.

FIGS. 5A and 5B are views of the back panel 20 of the cassette 1 when it is looked from the back side (the opposite side to the front panel 10). FIG. 5A shows the lock ON state, and FIG. 5B shows the lock OFF state.

A code storage element 200 is stuck on the same side as the side of the insertion hole 34 on the back panel back face 210. A clip 201 is disposed on the back panel back face 210 on the opposite side to the code storage element 200.

In the present embodiment, the code storage element 200 is a bar code label on which a pattern capable of being optically read is printed, and the code storage element 200 (bar code label) is stuck at a location distant from a corner of the cassette 1 by a predetermined distance X irrespective of the size of a cassette.

Moreover, as the code storage element 200, an element from which a written code can be read by using a radio technique for an electromagnetic wave, a microwave or the like may be used. When the element from which a written code can be read by using a radio technique for an electromagnetic wave, a microwave or the like is used, even if the positional relation between the code storage element 200 and a reading apparatus of the code storage element 200 is somewhat shifted, the code recorded in the code storage element 200 can be read accurately. Consequently, such an element is convenient. As such an element, for example, an element called as a noncontact ID label (such as an S label) or the like can be used.

When a code written in the code storage element 200 is read by means of the radio technique for an electromagnetic wave, a microwave or the like, the code storage element 200 may be disposed in the back panel 20 instead of being disposed on the back panel back face 210. Because reading and writing are performed by means of the radio technique, there is no necessity of disposing the code storage element 200 on the back panel back face 210. In this case, if a label on which an identification number (ID number) or the like of the photostimulable phosphor sheet 28 is printed is stuck on the back panel back face 210, the code thereof can be visually recognized. Consequently, the label makes the identification thereof easier.

Using both of the bar code reading system and the radio technique as the reading system would be more convenient. In this case, it is important that the contents of the bar code label and the contents recorded in the reading element by the radio technique correspond to each other.

In the code storage element 200, numbers indicating the identification number (ID number) and the date of manufacture of the photostimulable phosphor sheet 28, the lot number, the version number of the photostimulable phosphor, the size information of the cassette 1, the sensitivity correction information (or sensitivity information) of the photostimulable phosphor sheet 28, and the like is recorded as a code. When the sensitivity correction information (or the sensitivity information) of the photostimulable phosphor sheet 28 is recorded, it is possible to correct the sensitivity of the photostimulable phosphor by reading the information. For example, by changing a voltage to be supplied to a photoelectric conversion element such as a photomultiplier to alter the reading sensitivity of the photoelectric conversion element, the sensitivity dispersion of the photostimulable phosphor sheet 28 is corrected to make it possible that the sensitivity for reading image information is always constant. Such sensitivity correction can be also achieved by, for example, performing the shift processing of digital data obtained by performing the AD conversion of an output of a logarithmic amplifier in accordance with sensitivity information. In this case, there is no necessity for changing the voltage supplied to the photoelectric conversion element such as the photomultiplier.

FIG. 6 is a view showing an embodiment of the radiographic image reading apparatus of the present invention.

An insertion opening 3 of a cassette, an ejection port 4 of a cassette, an opening and closing door 5 and casters 6 are prepared on an apparatus main body 2. Moreover, the apparatus main body 2 comprises a conveying section 40, a sub-scanning section 50, a reading section 60, a cassette insertion and ejection portion 70, a display and operation section 80 and a main body framework portion 90. The cassette insertion and ejection portion 70 has a structure by which the portion 70 can be easily dismounted from the apparatus main body 2.

Moreover, the sub-scanning section 50 and the conveying section 40 are built on the same substrate 92 of the main body framework portion 90. By disposing vibration-proof rubbers 93 between the substrate 92 and a bottom plate 91, a vibration-proof structure for preventing the propagation of the vibrations of the cassette insertion and ejection portion 70 to the sub-scanning section 50 is realized.

Moreover, vibration-proof rubbers 94 are disposed between the upper end of the sub-scanning section 50 and a not shown apparatus frame to strengthen the vibration-proof structure to the sub-scanning section 50.

By such a vibration-proof structure, even if a cassette is inserted into the insertion opening 3, a cassette is taken out from the ejection port 4 or the apparatus main body 2 is vibrated in the midst of reading image information from the photostimulable phosphor sheet 28 with the reading section 60, it can be prevented that noises caused by vibrations are generated in the read image information.

Moreover, because the sub-scanning section 50 and the conveying section 40 are built on the same substrate 92, a delivery location is not moved at the time of delivering the back panel 20 from the conveying section 40 to the sub-scanning section 50, as it will be described later. Consequently, the separation and combination operations of the front panel 10 and the back panel 20 can be stably and accurately implemented.

Moreover, for preventing the mechanisms on the conveying section 40 and the substrate 92 from interfering with each other when the conveying section 40 inclines, an opening portion sufficient for making the mechanisms on the conveying section 40 escape toward the side of the under surface of the substrate 92 is formed in the substrate 92. Moreover, the bottom plate 91 also has an opening portion for the similar reason. In such a way, by forming the opening portions for making the mechanisms on the conveying section 40 escape on the substrate 92 and the bottom plate 91, the apparatus main body 2 can be built to have a low height.

However, in the case where the opening portion is formed in the bottom plate 91, outside light enters the apparatus main body 2 to be a problem. Accordingly, a light shielding plate 95 which has a V-shaped depression and can be dismounted is prepared for covering the opening portion of the bottom plate 91, and the light shielding plate 95 is mounted on the bottom plate 91 in the state of being convex downward as denoted by a reference numeral 95a in FIG. 6. By the configuration described above, the mechanisms on the conveying section 40 escape to the under surface of the bottom plate 91 while the entering of the outside light into the inside of the apparatus main body 2 can be prevented.

However, the mounting of the light shielding plate 95 in the state of being convex downward as denoted by the reference numeral 95a in FIG. 6 makes the projecting portion of the light shielding plate 95 become a hindrance at the time of the conveyance of the apparatus main body 2. Accordingly, the light shielding plate 95 is mounted in the state of being convex upward as denoted by a reference numeral 95b in FIG. 6 at the time of the conveyance of the apparatus main body 2. By adopting such a configuration, the problem of the projecting portion of the light shielding plate 95 being a hindrance at the time of the conveyance of the apparatus main body 2 is removed.

As described above, the opening portion is formed in the bottom plate 91, and the V-shaped light shielding plate 95 for performing the light shielding of the opening portion is configured to be able to be mounted in both the states of being convex upward and downward for being mounted on the bottom plate 91 to take the state of being convex upward at the time of the conveyance of the apparatus main body 2 and to take the state of being convex downward at the time of the operation of the apparatus main body 2. Consequently, the rotation movement of the conveying section 40 is allowed while the height of the apparatus main body 2 can be lowered.

Next, the operation of the radiographic image reading apparatus of the present invention is described with reference to FIGS. 6-12.

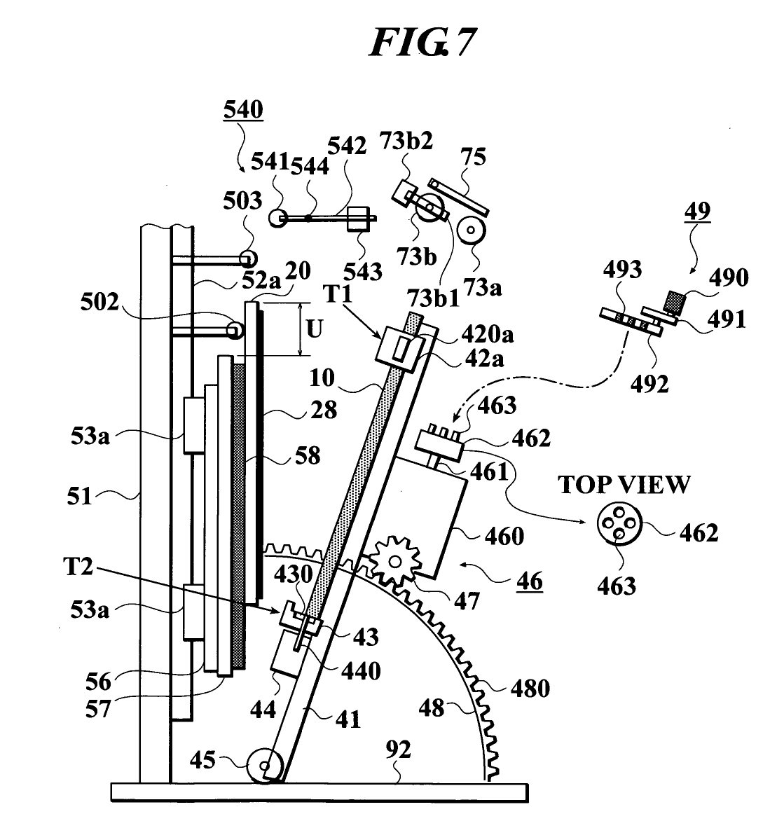

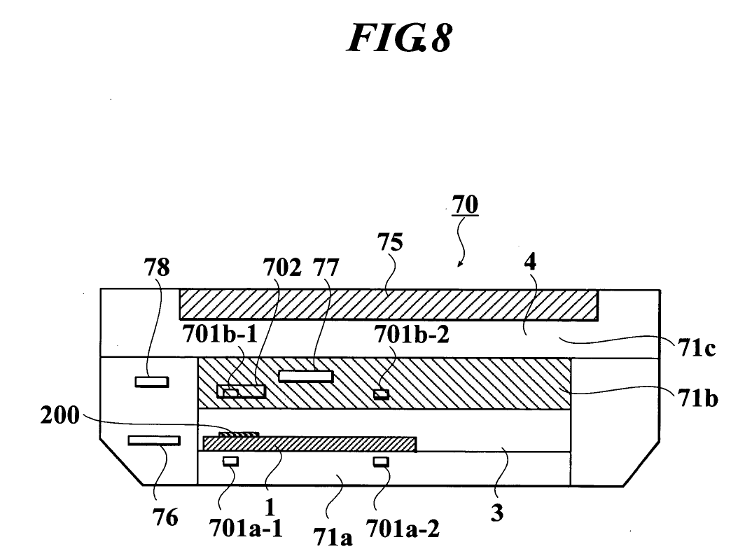

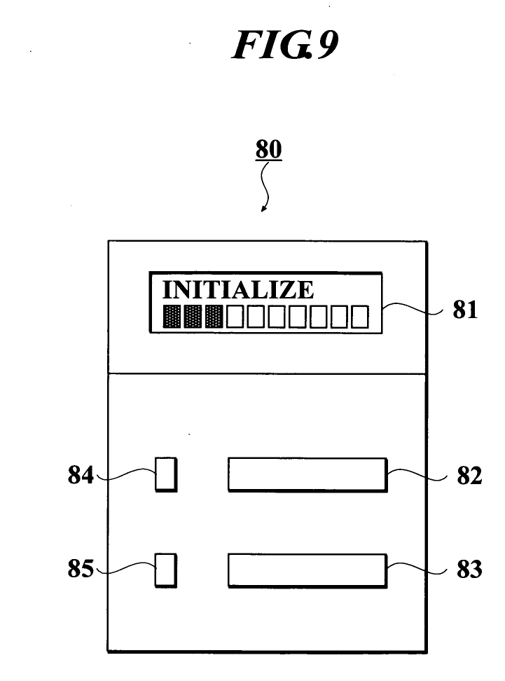

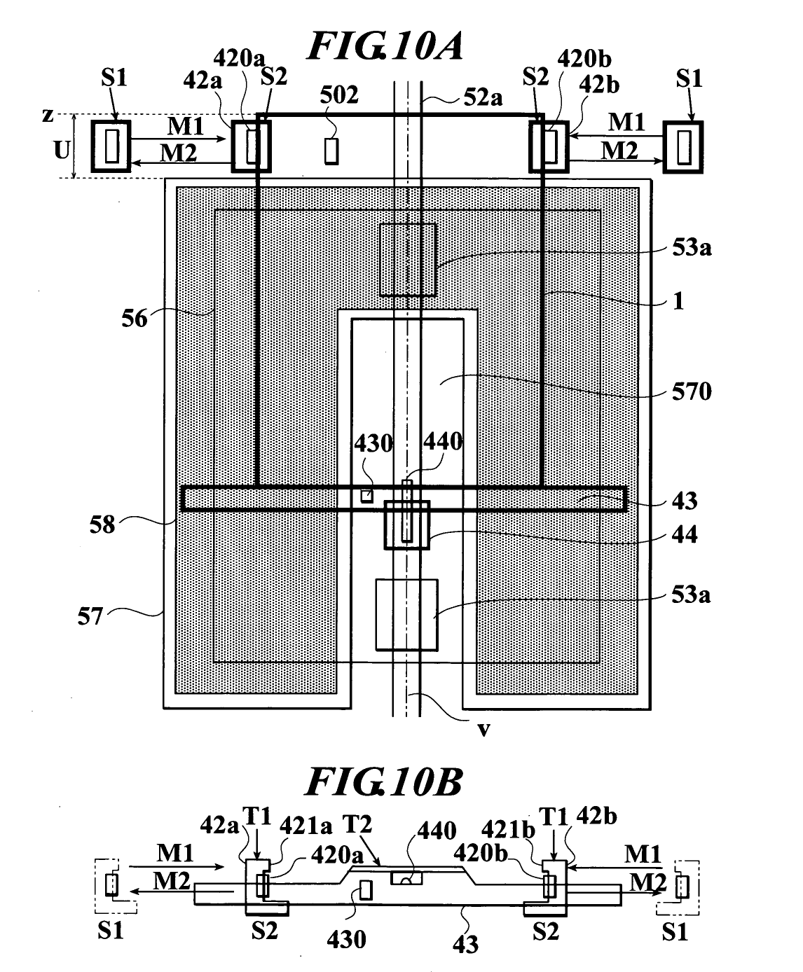

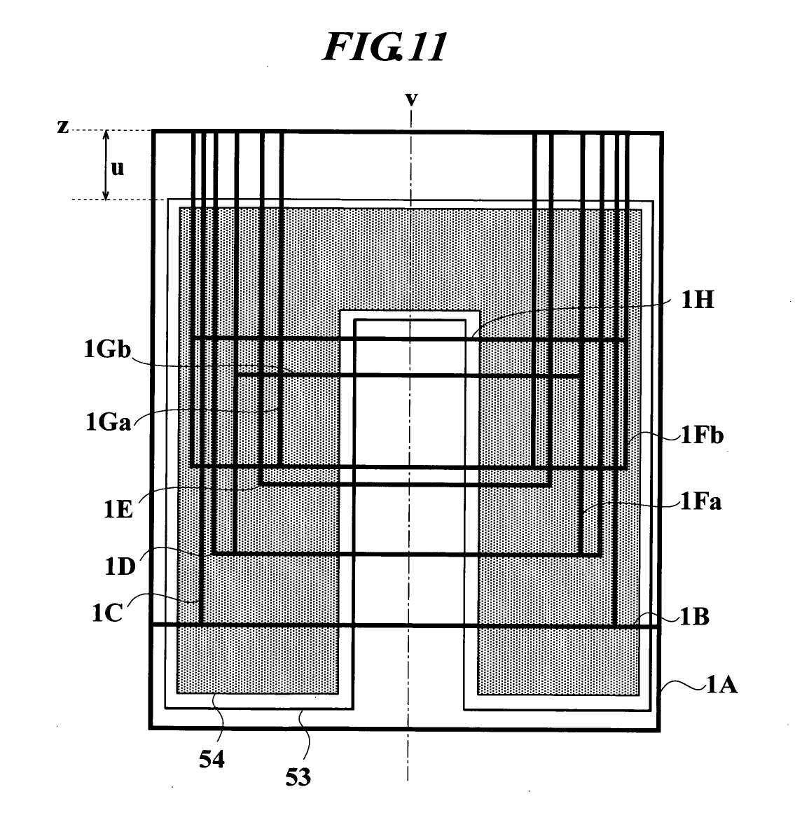

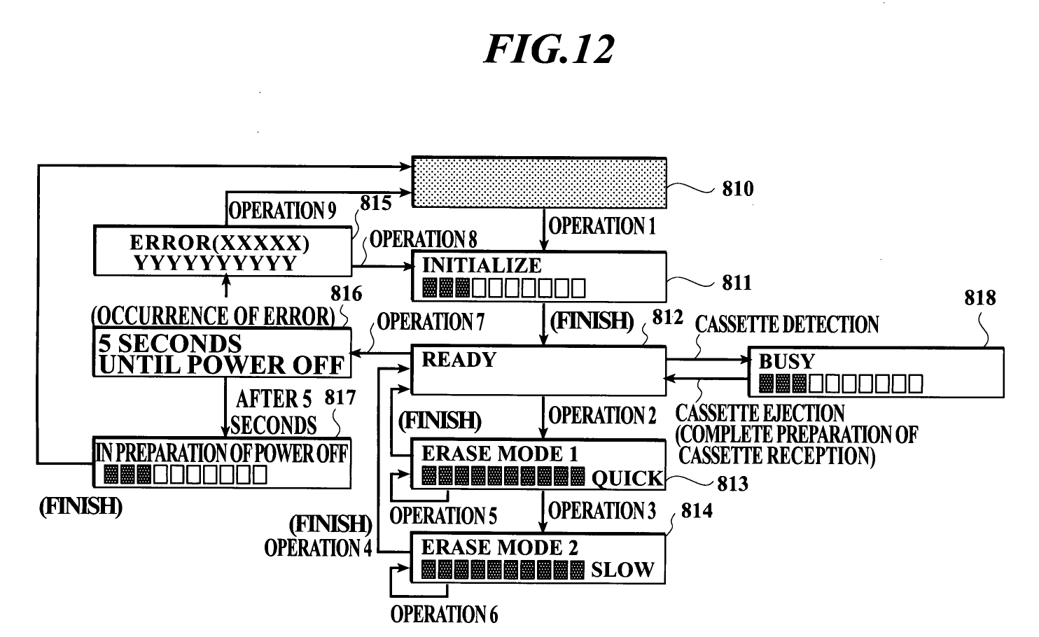

FIG. 7 is a view showing the relation between the conveying section 40 and the sub-scanning section 50 of the radiographic image reading apparatus of the present invention. FIG. 8 is view of cassette insertion and ejection portion 70 of the radiographic image reading apparatus of the present invention when it is looked from above. FIG. 9 is a view of a display and operation portion of the radiographic image reading apparatus of the present invention when it is looked from the front 80. FIGS. 10A and 10B are views showing the relation between the conveying section 40 and the sub-scanning section 50 at the time of the delivery of the back panel of the radiographic image reading apparatus of the present invention. FIG. 11 is a view showing positional relations of the cassette 1 by an upper side reference and a center reference of the radiographic image reading apparatus of the present invention. FIG. 12 is a transition diagram showing changes of display contents by a display section 81 of the radiographic image reading apparatus of the present invention.

First, a not shown circuit breaker is turned ON for starting the apparatus. Next, when an operation switch 82 shown in FIG. 9 is pushed (operation 1), a power source is supplied to a not shown control unit of the apparatus main body 2, and an operation lamp 84 is lighted. Then, a display indicating being in process of initialization is simultaneously displayed as shown in FIG. 9 or as denoted by a reference numeral 811 of FIG. 12 on the display section 81 (an LCD panel in the present embodiment). Simultaneously, the initialization of the apparatus main body 2 and the not shown control unit is begun. For making a user possible to know the time lapse until the end of the initialization well, a bar display using marks ▪ and □ shown in FIG. 9 and by the reference numeral 811 of FIG. 12 is performed, and down count display of replacing the number of the marks ▪ with the mark □ one by one as time lapses from the sate in which all marks are the marks ▪ to the state in which all marks are the marks □ is performed. Alternatively, the time lapse may be displayed by the number of seconds up to the end of the initialization. When the initialization ends, the display of the display section 81 becomes “READY” display as denoted by the reference numeral 812 of FIG. 12, and the apparatus becomes the state capable to insert the cassette 1 into the apparatus main body 2.

The radiographic image reading apparatus of the present invention includes at least two modes as its operation modes. One of them is a read mode for reading image information from the photostimulable phosphor sheet 28, and the other one is an erase mode for erasing image information from the photostimulable phosphor sheet 28. The read mode is automatically selected at the time of a start of the apparatus. Two modes of MODE 1 (high speed erasing) and MODE 2 (low speed erasing) are prepared for the erase mode. The MODE 1 (high speed erasing) is an erase mode to be implemented before radiography or after the lapse of a predetermined time from the last reading of image information. For example, the MODE 1 is an erase mode to be used after erasing all photostimulable phosphor sheets at every morning. On the other hand, the MODE 2 (low speed erasing) is, for example, an erase mode to be used in the case where radiography has been mistaken and the mistaken image information is unnecessary.

Next, transitions of the contents to be displayed on the erase mode and the display section 81 are described with reference to FIG. 12.

For transiting to the erase mode, an erasing switch 83 of FIG. 9 is continued to be pushed for three to five seconds (operation 2). By the operation 2, the display of the display section 81 changes from the “READY” display to a “ERASE MODE 1/▪▪▪▪▪▪▪▪▪▪QUICK” display as denoted by a reference numeral 813 of FIG. 12. Then, the apparatus transits to the MODE 1 (high speed erasing) of the erase mode and simultaneously down counting for ten seconds is begun, with the display similar to that at the time of the initialization (down count display of replacing the number of the marks ▪ with the marks □ one by one from the state in which all mars are the marks ▪ to the state in which all marks are the marks □ as time lapses) being displayed. When the apparatus is left in this state for ten seconds, the apparatus automatically restores to the read mode. When the erasing switch 83 is pushed (operation 3) before the lapse of ten seconds from the “ERASE MODE 1/▪▪▪▪▪▪▪▪▪▪” display, the display of the display section 81 changes to an “ERASE MODE 2/▪▪▪▪▪▪▪▪▪▪ SLOW” display, and the apparatus transits to the MODE 2 (low speed erasing) of the erase mode. Simultaneously, down counting for ten seconds is begun. When the apparatus is left in this state for ten seconds, the apparatus automatically restores to the read mode.

When the cassette 1 is inserted into the insertion opening 3 during the down counting (within ten seconds after the mode transitions) in both the MODE 1 (high speed erasing) and the MODE 2 (low speed erasing) of the erase mode (operation 5 or operation 6), the cassette 1 is taken into the inside of the apparatus main body 2 and erasing is performed. When the erasing has been completed and the next erasing becomes possible, the down counting is again displayed on the display section 81. After that, similarly to the above, by inserting the next cassette 1 into the insertion opening 3 before the end of the down counting, the erase operation can be continuously performed.

In such a manner, the down counting for ten seconds is performed after entering the erase mode, and the erasing is continuously performed when the cassette 1 is inserted into the insertion opening 3 before the end of the down counting. Thereby, in the case where a plurality of sheets is wanted to be continuously erased, the trouble of reentering the erase mode every time can be omitted. Moreover, when the cassette 1 is not inserted into the insertion opening 3 before the end of the down counting for ten seconds, the apparatus automatically restores to the read mode. Thereby, the risk of erasing the photostimulable phosphor sheet from which reading is wanted to be performed after the end of the erase operation by mistake is eliminated.

In the case where the operations of the radiographic image reading apparatus are wanted to end (the power is wanted to be turned off), the operation switch 82 is long pushed for five seconds (operation 7). A display “5 seconds until power OFF” is displayed on the display section 81 by the operation, and the display portion the number of seconds changes in the manner of 5, 4, 3, 2, 1. After the lapse of five seconds, the display becomes a “in preparation of power OFF” display. Together with the display, down counting is begun. When the power OFF is ready, the display section 81 becomes the state of lights out, and the power source having been supplied to the control unit of the apparatus main body 2 is deenergized.

Incidentally, it is needless to say that the intention of the present invention is the same even if the above-mentioned down count display is replaced with an up count display.

In any states and any modes, once an error is generated, the operation of the radiographic image reading apparatus stops, and an error message denoted by a reference numeral 815 shown in FIG. 12 is displayed on the display section 81. Hereupon, the letters “XXXXX” indicates the part in which an error code is displayed, and the letters “YYYYYYYYYY” is a part in which the operation which a user should do or the contents of the operation is displayed. Because the operation which the user should do or the contents of the operation is displayed on the display section 81 of the main body of the apparatus together with the error code as described above, the user can instantly perform restoring from the error.

Next, while referring to FIG. 6, the read operation in the read mode of the radiographic image reading apparatus is described. Incidentally, the contents to be described in the following pertaining to the operations of insertion and ejection of the cassette 1, and the movement of the cassette 1 in the apparatus are the same as those of the erase operations in the erase mode.

As shown in FIG. 6, the cassette 1 in which the radiography of a radiographic image has been performed is inserted into the insertion opening 3 in the direction of an arrow A1. At this time, the cassette 1 is inserted so that the insertion hole 14 is located on the lower side and the front face panel 13 of the front panel 10 is located on the oblique lower side. That is, the cassette 1 is inserted so that the reading surface of the photostimulable phosphor sheet 28 is located toward the oblique lower side. Moreover, the cassette 1 is inserted to be left justified along the wall on the left side of the insertion opening 3 in case of the present embodiment.

A cassette detection sensor 701, in which reference numerals 701a and 701b operate as a pair, is disposed in an insertion guide portion 71a in the cassette insertion and ejection portion 70. The reference numeral 701a denotes a light emitting unit emitting infrared light, and the reference numeral 702b denotes a light receiving unit receiving the infrared light emitted from the light emitting unit 701a. When the cassette 1 is inserted into the insertion opening 3, the infrared light emitted from the light emitting unit 701a of the cassette detection sensor is intercepted by the cassette 1, and the light does not arrive at the light receiving unit 702b of the cassette detection sensor. The apparatus main body 2 detects the insertion of the cassette 1 by the shielding of the infrared light as a cassette detection signal.

As shown in FIG. 8, at least two pairs of cassette detection sensors 701 in total of a pair of 701a-1 and 701b-1 on the left side of the insertion opening 3 and a pair of 701a-2 and 701b-2 at the center of the insertion opening 3 are prepared. Only when all of the at least two pairs of cassette detection sensors 701 issue detection signals, an insertion roller 72a is driven by a not shown insertion motor, and the cassette 1 is conveyed into the direction of the arrow A1 by the driving of the insertion roller 72a. Then, the tip of the cassette 1 reaches an insertion opening shutter 74. After the tip of the cassette 1 reached the insertion opening shutter 74, the insertion roller 72a is driven for a while. Thereby, even if the cassette 1 is inserted in the state of being inclined, the cassette 1 can be aligned to be horizontal to the insertion opening shutter 74. An insertion roller 72b is a driven roller, and the cassette 1 is nipped by the force sufficient for the conveyance thereof by the insertion roller 72a and the insertion roller 72b.

In the case where at least one pair of the cassette detection sensors 701 among at least two pair of the cassette detection sensors 701 does not issue any detection signal, the apparatus recognizes that the cassette 1 was not inserted to be left justified, and a warning message indicating the insertion of the cassette 1 to be left justified is displayed on the display section 81 (an liquid crystal panel capable of displaying letters and signs in the present embodiment). Even when the cassette 1 having any size is inserted in any direction, a detection signal is certainly issued from the cassette detection sensors 701a-2 and 701b-2 by disposing the pair of cassette detection sensors 701a-2 and 701b-2 in the insertion opening 3 like the present embodiment. Consequently, even when the cassette 1 is not inserted to be left justified, a warning message warning a user to insert the cassette 1 to be left justified is certainly displayed.

Moreover, because simultaneously with the display of the warning message, an insertion opening indicator 76 blinks and an alarm sounds, thus, the user never misses the abnormal insertion of the cassette 1.

As described above, because the abnormal insertion is immediately informed after the insertion of the cassette 1 (before a part of the cassette 1 is totally taken in the apparatus main body), the user can immediately reinsert the cassette 1 and can take corrective action to left justify the cassette 1 without losing time.

When the rotation of the not shown insertion motor, which is begun in response to the detection of the cassette 1, stops, a code reading section 702 reads above-mentioned various information including the size information of the cassette 1 and other information from the code storage element 200 of the cassette 1. Although the code storage element 200 is a bar code label and the code reading section 702 is a bar code reader in the present embodiment, they are not limited to those mentioned above.

FIG. 8 is a view of the cassette insertion and ejection portion 70 when it is looked from above. In the present embodiment, the code reading section 702 is disposed on the left side of the insertion opening 3. Accordingly, the embodiment is configured as follows. That is, by inserting the cassette 1 into the insertion opening 3 to be left justified, the location of the code storage element 200 (bar code label) faces the code reading section 702 (bar code reader), and the code storage element 200 (bar code label) reaches within a range in which the reading of the code reading section 702 (bar code reader) can be performed. Because the width of the code of the code storage element 200 (the width of the bar code label) is configured to be in a size smaller than the range in which the code reading section 702 (bar code reader) can perform reading, the configuration enables the code reading section 702 (bar code reader) to read the information of the code storage element 200 (bar code label) on the cassette 1 accurately even if the insertion location of the cassette 1 is somewhat shifted, that is, even if the cassette 1 is somewhat distant from the wall of the left side of the insertion opening 3. By such a configuration, the user is not required to be anxious of the insertion of the cassette 1, and the stress related to the insertion of the cassette 1 can be reduced.

The cassette 1 is inserted into the insertion opening 3 to be left justified in the present embodiment, but it is needless to say that the cassette 2 may be inserted to right adjust. In this case, the code reading section 702 is disposed on the right side of the insertion opening 3.

The insertion opening indicator 76 is disposed on the cassette insertion and ejection portion 70. In the state in which a cassette can be inserted into the insertion opening 3, that is, in the sate in which the cassette 1 does not exist in the insertion opening 3 and the insertion opening shutter 74 is closed, the insertion opening indicator 76 lights, and the display section 81 performs the display indicating the state capable of the insertion of the cassette, such as the display of “READY”.

At the time of the state in which the insertion of a cassette into the insertion opening 3 is prohibited, namely in the case where the cassette 1 exists in the insertion opening 3, in the midst of taking the cassette 1 to the inside of the apparatus main body 2, or in the sate in which the insertion opening shutter 74 is opened immediately after the cassette 1 has been taken to the inside of the apparatus main body 2, the insertion opening indicator 76 goes out to indicate the prohibition state of the insertion of the cassette. The display section 81 performs the display indicating that the cassette 1 is processing in the apparatus main body 2, such as the display of “BUSY”.

In the present embodiment, when the cassette is processing in the apparatus main body 2, namely during a period from the detection of the cassette 1 in the insertion opening 3 to the state capable of taking in the next cassette 1 through reading processing, erasing processing and cassette ejection processing, the display section 81 displays the letter of “BUSY”. During the display of “BUSY”, the bar display using the marks ▪ and □ as denoted by the reference numeral 818 of FIG. 12 is performed for the better understanding of the lapse of the processing. The up count display or the down count display in which the number of the marks □ is replaced with the marks ▪ one by one from the state in which all marks are the marks □ to the state in which all marks are the marks ▪ as the laps of time is performed. It is preferable to implement the display switching from the marks □ to the marks ▪ in proportion to the progress of the processing contents. When the display switching from the marks □ to the marks ▪ is sequentially implemented at the timing at which, for example, the following processing contents are changed: the processing of taking the cassette 1 from the insertion opening 3 into the inside of the apparatus main body, the conveyance processing of the cassette 1 in the apparatus main body 2, the processing of reading image information from the photostimulable phosphor sheet 28, the processing of erasing the image information remaining in the photostimulable phosphor sheet 28, the processing of ejecting the cassette 1 to the ejection port 4, and the like, then the outline of which processing the user is now performing can be known, and the time until the processing completion can be roughly estimated to be very convenient. Moreover, the time lapse until the end of processing may be displayed by the number of seconds. When reading processing and erasing processing have ended and the cassette 1 has been ejected to the ejection port 4 and then the apparatus is in the state capable of taking the next cassette 1 therein, the display section 81 displays the letters “READY” indicating the state capable of inserting a cassette.

Moreover, in the case of the abnormal insertion of the cassette 1 or in the case of the abnormal insertion of a thing other than the cassette 1, the insertion opening indicator 76 blinks, and the display section 81 displays a warning error message indicating the occurrence of the abnormal insertion, and further an alarm is generated for informing the user of the occurrence of the abnormal insertion. In such a way, in the case where the abnormal insertion of the cassette 1 is detected, the cassette 1 is not taken to the inside of the apparatus main body 2.

Hereupon, the abnormal insertion means the following cases.

1) a case where at least one pair of the cassette detection sensors 701 among at least two pairs of the cassette detection sensors 701 did not issue any detection signal (such as the case where a cassette was not inserted to be left justified). In this case, the display section 81 displays a warning error message warning a user to left justify the cassette 1.

2) a case where the code reading section 702 cannot read any codes, or a case where the code reading section 702 read a code which the section 702 could not identify. In this case, the display section 81 displays a warning error message indicating the occurrence of a reading error of the code storage element 200 (a bar code in the present embodiment).

As the case where the code reading section 702 cannot read any codes, or the case where the section 702 read a code which the section 702 could not identify, the following cases are considerable:
1) the cassette 1 was inserted in the state of being inverted,
2) the cassette 1 was inserted in the state of being reversed,
3) a different cassette or an odd thing was inserted,
4) codes recorded in the code storage element 200 (bar code label) became dirty, or was destroyed, and
5) the code storage element 200 (bar code label) is not stuck, or is not located correctly.

When the code reading section 702 accurately reads a code, the insertion opening shutter 74 opens and the insertion roller 72a is driven by the not shown insertion motor. Consequently, the cassette 1 is taken into the apparatus main body 2 along a dotted line a in the direction of an arrow A2.

When the cassette 1 is taken to the inside of the apparatus main body 2, the insertion shutter 74 closes, and the throwing indicator 76 of FIG. 8 lights (the throwing indicator 76 lights when the cassette 1 is in the state capable of being inserted, and goes out in the state of the insertion prohibition). Then, the apparatus becomes the state in which the next cassette 1 can be inserted. When the next cassette 1 is inserted at this point (the throwing indicator 76 puts out at this point), the throwing rollers 72a and 72b operate and the cassette 1 advances to the reading location of the code storage element 200 by the code reading section 702 and then the cassette 1 stops in the state of being nipped by the throwing rollers 72a and 72b in the case where the cassette 1 did not abnormally thrown in. At this point, the code reading section 702 reads the code storage element 200. When normal reading is confirmed, the subsequently inserted cassette 1 continues to wait in the insertion opening 3 till the apparatus main body 2 becomes the state capable of receiving the cassette 1 (till a rotation movement body 41 returns to the location of the dotted line a of FIG. 6 to be in a retraction state after the reading of the cassette 1 taken to the inside of the apparatus main body 2 before has been completed and the cassette 1 has been ejected from the ejection port 4). When the apparatus main body 2 becomes the state capable of receiving the cassette 1, the cassette 1 is taken to the inside of the apparatus main body 2. As described above, two cassettes 1 can be received almost continuously, the operating efficiency is improved. Moreover, when an ejection switch 78 is pushed in the state that the cassette 1 is stopped in the state of being nipped by the throwing rollers 72a and 72b, the throwing rollers 72a and 72b reverse, and the cassette 1 is ejected to the insertion opening 3. Consequently, the ejection function of the cassette 1 by the ejection switch 78 is useful for the case where it was found that the cassette 1 was inserted by mistake, or the like.

The rotation movement body 41 of the conveying section 40 has been already waiting at the location of the dotted line a at the time when the insertion roller 72a starts, and the cassette 1 conveyed by the insertion rollers 72a and 72b from the insertion opening 3 is received by an elevating base 43 performing a vertical operation along the rotation movement body 41. An elevating base sensor 430 is disposed on the elevating base 43. When the elevating base sensor 430 detects a tip of the cassette 1, the elevating base 43 operates at almost the same speed as the taking speed of the cassette 1, and descends on the rotation movement body 41 together with the cassette 1. The elevating base 43 is controlled so that the upper end of the cassette 1 stops at the location denoted by a reference numeral Z in FIGS. 10A and 11 in accordance with the cassette size information read from the code storage element 200.

When the upper end of the cassette 1 stops at the location shown by the reference numeral Z of FIGS. 10A and 11, width pushing sections 42a and 42b operate in accordance with the cassette size information read from the code storage element 200. That is, the width pushing sections 42a and 42b staying at retraction locations S1 of FIGS. 10A and 10B move into the directions of arrows M1, and stop at locations S2 where the width pushing sections 42a and 42b hold the cassette 1. At this time, width pushing sensors 420a and 420b turn from OFF to ON. In the case where the width pushing sensors 420a and 420b do not turn to ON, the error information is displayed on the display section 81 and the operation is stopped.

When the width pushing sections 42a and 42b stay at the locations S2 where the width pushing sections 42a and 42b hold the cassette 1, the width pushing sections 42a and 42b hold the cassette 1 in the form of holding only the frame 11 of the front panel 10 with projecting portions 421a and 421b on the side of T1 surfaces shown in FIG. 10B. Because the width pushing sections 42a and 42b do not hold the back panel 20 at this time, turning off the locking of the cassette 1 would enable the back panel 0.20 to be dismounted without the interference of the projecting portions 421a and 421b of the width pushing sections 42a and 42b. Because the width pushing sections 42a and 42b are configured to hold only the front panel 10 and not to hold the back panel 20 in such a way, the width pushing mechanism and the holding mechanism of the cassette 1 can be commonly used, and consequently the number of parts of the apparatus can be reduced and the control of the apparatus can be simplified.

FIG. 11 is a view showing positional relations of different cassette sizes on the rotation movement body 41. A reference numeral 1A denotes a cassette of Hansetsu (14×17 inch) size, a reference numeral 1B denotes a cassette of Daikaku (14×14 inch) size, a reference numeral 1C denotes a cassette of Dai-yotsugiri (11×14 inch) size, a reference numeral 1D denotes a cassette of Yotsugiri (10×12 inch) size, a reference numeral 1E denotes a cassette of Mutsugiri (8×10 inch) size, a reference numeral 1Fa denotes a cassette of the 24×30 cm size, a reference numeral 1Fb denotes a cassette for radiographing mammography of the 24×30 cm size, a reference numeral 1Ga denotes a cassette of the 18×24 cm size, a reference numeral 1Gb denotes a cassette for radiographing mammography of the 18×24 cm size, and a reference numeral 1H denotes a cassette for dental use of the 15×30 cm size. The location of the elevating base 43 is controlled in order that the upper ends of all of the cassettes accord with the location of the arrow Z irrespective of their sizes. It is supposed that the method for controlling the location of the cassette 1 in order that the upper end thereof always stays at the same location of the rotation movement body 41 as described above is called as upper side reference control.

The advantages of the upper side reference control are the following two respects.

1) Because the time necessary for the sub-scanning section 50 to convey the back panel 20 to a reading location B can be minimized independently of cassette sizes, the processing ability (throughput) of the apparatus can be improved.

2) Because the upper end of the back panel 20 can be projected from a sub-scanning moving plate 57 by the same distance U independently of cassette sizes (see FIGS. 7, 10A and 11), it is possible to let the surfaces of the tip T1 surfaces of the width pushing sections 42a and 42b (see FIGS. 7 and 10B) to escape to the inner part side of the apparatus from the sub-scanning moving plate 57 and the magnet 58 without the interference with the sub-scanning moving plate 57 and the magnet 58. Moreover, the width pushing sections 42a and 42b can hold the cassette 1 in the form of holding the frame 11 of the front panel 10 of the cassette 1 by means of the projecting portions 421a and 421b without the interference with the sub-scanning moving plate 57 and the magnet 58.

Of course, a method of the control of under side reference, namely a method of controlling the location of the elevating base 43 in order that the lower end of the cassette 1 may always stay at the same location of the rotation movement body 41, may be adopted. In this case, because the elevating base 43 can be made to descend to the lower end of the apparatus independently of the size of the cassette 1, the control of the mechanism can be simplified. Incidentally, the above-mentioned two advantages cannot be obtained by this method.

A dotted line V in FIGS. 10A and 11 is the center line of the sub-scanning moving plate 57. The width pushing sections 42a and 42b are controlled in order that the centers of all of the cassettes accord with the center line of the sub-scanning moving plate 57. That is, when the taking of the cassette 1 to the inside of the apparatus main body 2 has ended, as shown in FIGS. 10A and 10B, the width pushing sections 42a and 42b move from the retraction locations S1 into the direction denoted by the arrows M1 to stop at the locations S2 where the width pushing sections 42a and 42b hold the cassette 1 (it is supposed that the cassette 1 of FIG. 10A is one having the Mutsugiri (8×10 inch) size). During this movement, the cassette 1 having been located on the left side on the elevating base 43 moves to the center location on the elevating base 43. After that, all of a series of processing from the conveyance of the cassette 1 by the conveying section 40 and the sub-scanning of the back panel 20 by the sub-scanning section 50 to the ejection of the cassette 1 are implemented at this center location. The control is called as center reference control. As described above, when the cassette 1 is inserted into the insertion opening 3, the cassette 1 is inserted to be left justified (this control is called as one-side reference control). The one-side reference control is altered to the center reference control at the time of the taking of the cassette 1 to the inside of the apparatus main body 2.

Normally, in the case of conveying a film, or in the case of conveying a photostimulable phosphor sheet, the one-side reference control, by which the film or the photostimulable phosphor sheet is put to one side to be conveyed, is performed. In the case of the present embodiment, because the conveying section 40 (rotation movement body 41) and the sub-scanning section 50 must deal with variously sized cassettes 1 and back panels 20, the locations of the centers of gravity of the cassette 1 and the back panel 20 in the horizontal direction and the center of the sub-scanning moving plate 57 do not accord with each other by the one-side reference control, and consequently there is the possibility that the balance of the sub-scanning, which requires precise conveyance, is lost and the speed thereof becomes uneven at the time of reading. Moreover, because the back panel 20, to which the photostimulable phosphor sheet 28 is attached, has a relatively large weight in comparison with a film or a simple body of a photostimulable phosphor sheet, the badness of the balance of the one-side reference control is not preferable for reliability and stability. Accordingly, the center reference control is preferable for the present embodiment.

However, it is preferable to perform the one-side reference control as to the insertion of the cassette 1, as described above. That is, by performing the one-side reference control (namely, inserting the cassette 1 into the insertion opening 3 to be left justified or right justified), the location of the code storage element 200 (bar code label) can be configured in order that the code storage element 200 faces the code reading section 702 (bar code reader) and also the code storage element 200 reaches within the range in which the code reading section 702 can perform reading. In the case where the insertion of the cassette 1 is performed by the center reference control, at the stage at which the cassette 1 has been inserted into the insertion opening 3, the locations of the code storage element 200 and the code reading section 702 are shifted from each other and the code of the code storage element 200 cannot be frequently read. Consequently, before the reading of the code storage element 200, some cassette location adjusting mechanism becomes necessary, and then the apparatus becomes complicated and the reliability thereof lowers.

However, from the viewpoint of the user's easiness of the insertion of the cassette 1, it is preferable not to set a reference at the time of the insertion of the cassette 1, but to enable the user to insert the cassette 1 from a free location in the insertion opening 3. As the means for realizing the above mechanism, using a noncontact ID label (such as an S label) as the code storage element 200 is considerable. In this case, because the code reading section 702 uses a radio technique using an electromagnetic wave, a microwave or the like to read the information recorded on the code storage element 200, the shift of the positional relation between the code reading section 702 and the code reading section 702 to a certain degree does not cause any problems.

In the case where an element necessary for being optically read such as a bar code is selected as the code storage element 200, the information of the code storage element 200 may be read after the cassette 1 is aligned in the insertion opening 3 or in the apparatus main body 2 by the center reference or the one-side reference.

Moreover, because the T2 surface of the elevating base 43 and the sub-scanning moving plate 57 (or the magnet 58) interfere with each other at the time of the delivery of the back panel 20 between the conveying section 40 (rotation movement body 41) and the sub-scanning section 50, an interference avoiding opening 570 is formed on the sub-scanning moving plate 57 for a measure of avoiding the interference (see FIG. 10A). Because the location of the interference avoiding opening cannot be specified and a more complicated mechanism becomes necessary by the one-side reference control, the center reference control is preferable in the present embodiment also from this viewpoint.

Though the present embodiment adopts the center reference control, even the adoption of the one-side reference control avoiding the above-mentioned problem would not damage the essence of the present invention.

The rotation movement body 41 of the conveying section 40 comprises a rotation axis 45, and the rotation movement body 41 can freely rotate and move around the rotation axis 45 as the rotation center by driving a conveyance motor unit 46 within a range of at least from the dotted line a to a dotted line c (the range of an angle θ). The rotation movement is implemented by the driving of a pinion gear 47 by the conveyance motor unit 46 and by the rotation movement of the pinion gear 47 on an irregularly shaped rack teeth 480 formed on an arc of a rotation supporting plate 48.

When the cassette 1 is taken to the inside of the apparatus main body 2 by the conveying section 40, the conveyance motor unit 46 is driven and the pinion gear 47 rotates. Then, the rotation movement body 41 rotates and moves around the rotation axis 45 as the rotation center from the location of the dotted line a of FIG. 6 to the location of the dotted line c into the direction of an arrow A3. When the rotation movement body 41 has rotated and moved to the location of the dotted line c, the back panel back face 210 of the cassette 1 comprising the magnetic substance is absorbed to the magnet 58 by the magnetic force.

At this time, for controlling the pressing amount of the cassette 1 to the magnet 58, the cassette 1 is pressed to the side of the magnet 58 by a mechanism (not shown) for pressing the front panel 10 of the cassette 1 to the side of the magnet 58 by a spring pressure.

A lock opening and closing mechanism 44 and a locking pin 440 for turning on and off the locking mechanism of the cassette 1 are disposed on the elevating base 43. By the vertical motion of the locking pin 440, the locking mechanism of the cassette 1 can be turned on and off.

The sub-scanning section 50 comprises a supporting column 51, sub-scanning rails 52a and 52b, sub-scanning movable portions 53a and 53b, pulleys 55, a steal belt 54, a sub-scanning moving plate fixing member 56, the sub-scanning moving plate 57, the magnet 58, a balancing weight 59, and a drive unit (not shown) comprising a sub-scanning motor and a speed reducer. The sub-scanning moving plate 57 is fixed to the sub-scanning movable portions 53a with the sub-scanning moving plate fixing member 56 put between them. Both ends of the steal belt 54 are fixed to the sub-scanning moving plate fixing member 56 and the balancing weight 59, respectively. The pulleys 55 are connected to the not shown drive unit, and transmits the power of the not shown drive unit to the steal belt 54. The sub-scanning moving plate 57 and the balancing weight 59 receive the power of the not shown drive unit and vertically move the sub-scanning rails 52a and 52b, respectively. As the sub-scanning rails 52a and 52b, linear guides, linear bearing guides or the like, each having a high conveyance performance can be used. As the not shown speed reducer, a planet roller speed reducer, a pulley speed reducer or the like can be used.

In the present embodiment, the magnet 58 is a rubber magnet (permanent magnet) having a predetermined area. The rubber magnet may be formed by sticking a sheet having the interference avoiding opening 570 on the whole surface of the sub scanning moving plate 57 as shown in FIG. 10A, or the rubber magnet may be formed by being divided into a predetermined number of sheets to be stuck on the sub-scanning moving plate 57. Moreover, the rubber magnet can be formed in an arbitrary shape. Moreover, permanent magnets or electromagnets other than the rubber magnet may be used.

The surface portion of the magnet 58 absorbing the back panel back face 210 has a high planarity. It is considered that the reading surface of the photostimulable phosphor sheet 28 becomes a complete plane as much as possible by making the magnetic substance surface of the back panel back face 210 follow the plane of the magnet 58 when the magnet 58 absorbs the back panel back face 210. Consequently, even if the back panel 20 is deformed or warped, the deformation or the warp is remedied when the back panel back face 210 is absorbed to the magnet 58. The reading surface of the photostimulable phosphor sheet 28 can thus secure its planarity.

When the back panel 20 is absorbed by the magnet 58, the locking pin 440 housed in the lock opening and closing mechanism 44 attached to the elevating base 43 ascends, and the end of the locking pin 440 is inserted to the insertion hole 14 of the front panel 10. By this operation, the locking of the cassette 1 having stayed in the lock ON state is released, and the cassette 1 transits to the lock OFF state. That is, the back panel 20 and the front panel 10 enter the separable state. When the cassette 1 transits to the lock OFF state, the locking pin 440 descends to be housed in the lock opening and closing mechanism 44 again.

When the locking of the cassette 1 is released and the cassette 1 transits to the lock OFF state, the rotation movement body 41 rotates and moves into the direction of an arrow A6, and stops at a retraction location (for example, the location of a dotted line b). By the operation, the back panel 20 and the front panel 10 can be completely separated.

FIG. 7 is a view showing a state in which the back panel 20 and the front panel 10 have been completely separated and the rotation movement body 41 has stopped at the retraction location. By retracting the front panel 10 with a sufficient angle from the back panel, it can be prevented that the back panel 20 and the front panel 10 interfere with each other when the back panel 20 performs the sub-scanning operation. The section for performing a series of operations for separating the back panel 20 and the front panel 10 from each other in such a way is generically named as a separation section.

A reference numeral 502 in FIGS. 6 and 7 denotes a back panel absorption sensor. The back panel absorption sensor 502 turns on when the back panel 20 is absorbed by the magnet 58, and turns off when the back panel 20 is separated from the magnet 58. When the back panel absorption sensor outputs OFF in a time zone in which the sensor should be ON, the back panel 20 is considered to peeled off from the magnet 58 or to fall, and the OFF signal is judged to be an error.

When the back panel 20 has been completely separated from the front panel 10 by the separation section, the not shown drive unit operates to convey (sub-scan) the back panel 20 into the direction of an arrow A4 (upward direction). During the sub-scanning operation, the main scanning of the photostimulable phosphor sheet 28 is performed into the direction perpendicular to the sub-scanning direction by a laser beam B emitted from a laser scanning unit 61.

When the laser beam operates to the photostimulable phosphor sheet 28, photo-stimulated light (image information) proportional to the radiation energy accumulated in the photostimulable phosphor sheet 28 is emitted. The photo-stimulated light is condensed by a condenser mirror 64 and an edge face of a light guide 62, and is collected on a condenser tube 63 through the light guide 62. It is preferable to use a condenser tube having a structure described in, for example, the specification of Japanese Patent Application No. 2000-103904 as the condenser tube 63. A not shown photoelectric conversion element such as a photomultiplier is disposed on the edge face of the condenser tube, which converts the condensed photo-stimulated light to an electric signal. The photo-stimulated light converted to the electric signal receives predetermined signal processing as image data. After that, the image data is output from the apparatus main body 2 to an operation terminal, an image storage apparatus, an image display apparatus, and an image output apparatus such as a dry imager (all being not shown) through a not shown communication cable. The image information reading section comprising the laser scanning unit 61, the light guide 62, the condenser tube 63, the photoelectric conversion element and the like as described above is called as the reading section 60. It is needless to say that the reading section 60 may be achieved by a configuration different from that of the present embodiment as long as the section is for reading image information from the photostimulable phosphor sheet 28.

Now, several kinds of control pertaining to the read operation are described with reference to FIG. 6. A reference numeral 503 denotes a read beginning sensor. When the sub-scanning moving plate 57 ascends, the sensor changes from OFF to ON. By utilizing the timing, the not shown control unit calculates a read beginning time and a laser beam beginning time.

A reference numeral 540 denotes a peeling detection section. The peeling detection section 540 detects whether or not the photostimulable phosphor sheet 28 and the supporting plate 27, each stuck on the back panel 20, rise from the back panel, or whether or not the photostimulable phosphor sheet 28 and the supporting plate 27 begin to peel off. In the case where the photostimulable phosphor sheet 28 and the supporting plate 27 rise from the back panel or begin to peel off, it is apprehended that the photostimulable phosphor sheet 28 and the supporting plate 27 interfere with the condenser mirror 64 or the edge face of the light guide 62 to destroy the condenser mirror 64 or the light guide 62, or that the surface of the photostimulable phosphor sheet 28 is damaged. Accordingly, the peeling detection section 540 detects the rise or the peeling of the photostimulable phosphor sheet 28 and the supporting plate 27. When the rise or the peeling of the photostimulable phosphor sheet 28 and the supporting plate 27 is detected, the sub-scanning operation is stopped, and the sub-scanning moving plate 57 is made to descend to the combination location with the front panel 10.

The peeling detection section 540 is realized by, for example, a combination of a roller and a sensor. A peeling detection roller 541 having the a length almost equal to the length in the short side direction of the Hansetsu size is held in the horizontal direction, and a presser bar 542 used for fixing the shaft of the peeling detection roller 541 is extended to the side of the front face of the apparatus to dispose a peeling detection sensor 543 at the rear end thereof. When the photostimulable phosphor sheet 28 and the supporting plate 27 are contacted with the peeling detection roller 541 at the time of ascending, the presser bar 542 inclines around the supporting shaft 544 as the fulcrum, and the peeling detection sensor 543 detects the inclination to notify the not shown control unit of a peeling detection signal.

When the reading of image information from the photostimulable phosphor sheet 28 is completed, the not shown drive unit begins to convey the back panel 20 into the direction (down direction) of an arrow A5. During conveying the back panel 20 into the direction of the arrow A5, an easing section 65 emits erase light C to erase the image information remaining in the photostimulable phosphor sheet 28. As an erase lamp used in the easing section 65, a halogen lamp, a high intensity fluorescent lamp, LED array or the like can be used.

In the present embodiment, n erase lamps (n>1) are prepared. Moreover, a not shown lamp burn-out detection section monitors the generation of the burn-out of the erase lamp. When the burn-out of m erase lamps among n erase lamps (m<n) is detected by the lamp burn-out detection section, the erase speed is controlled to be about (n−m)/n of the erase speed in the case where no lamp burn-out is generated in order that the easing can be performed with the same light quantity as that in the case where no lamp burn-out is generated. By such control, even when the lamp burn-out is generated, it is prevented that the apparatus cannot be used, and the reading operation and erasing operation can be continued after the lamp burn-out.

Moreover, because there is no erasing by using erase light of a lowered light quantity owing to lamp burn-out, there is no risk of damaging diagnosis information because the next radiography is performed in the insufficient erasing state and the remaining previous image which was not erased becomes noises of the next image information.

Moreover, when the generation of the lam burn-out of all of the n erase lamps is detected by the lamp burn-out detection section, the error indicating the lamp burn-out of all of the erase lamps is displayed on the display section 81, and both of the succeeding read operation and erase operation are controlled to be impossible to perform. By this control, the reading operation and the erasing operation in the state in which erasing cannot be performed is prohibited for preventing the accident of performing radiography using the cassette 1 to which no erasing has been performed.

In the present embodiment, in the case where the read mode is selected, because the embodiment is configured in order that reading of image information is performed on the approach route (conveying toward the upward direction) of the sub-scanning section 50 and erasing of remaining image information is performed on the return route (conveying toward the downward direction) of the sub-scanning section, the time necessary for the reciprocating motion of the sub-scanning section is not wastefully consumed, but can be effectively utilized. Thereby, the processing ability (throughput) of the radiographic image reading apparatus can be improved.

Moreover, when the erase mode is selected, erasing is performed on the approach route (conveying toward the upward direction) of the sub-scanning section 50, and the erasing is also performed on the return route (conveying toward the downward direction) of the sub-scanning section 50. Consequently, the cycle time of the erase mode can be improved in comparison with the cycle time of the read mode.

Moreover, when the erase mode is selected, instead of performing the erasing on the approach route (conveying toward the upward direction) of the sub-scanning section 50, the erasing may be performed only on the return route (conveying toward the downward direction) of the sub-scanning section 50. In this case, the improvement of the cycle time of the erase mode cannot be expected, but the control of the erase mode can be made to be equivalent to the control of the read mode, and consequently the control can be simplified.

Moreover, in the present embodiment, because the easing section 65 is disposed at the lower stage of the reading section 60 in the vertical direction, the moving direction of the sub-scanning section 50 can be switched to the return route direction (downward direction) immediately after the end of the read operation of the image information by the reading section 60. Thereby, because the erase operation can be begun without time loss during the reciprocating motion of the sub-scanning section 50, the processing ability (throughput) of the radiographic image reading apparatus can be further improved.

Moreover, because the lower end of the back panel 20 does not pass through the reading location B in the reading section 60 by the disposition of the easing section 65 at the lower stage of the reading section 60 in the vertical direction, the accident in which the lower end of the back panel interferes with the condensing member such as the light guide 62 to makes it impossible to make the back panel descend can be prevented beforehand. Consequently, the reliability and the stability of the apparatus can be improved.

At the time of the descending of the back panel 20, the location of the origin of the sub-scanning direction is confirmed with a sub-scanning origin sensor 501, the back plate 20 is made to ascend to the location where the back plate 20 has been delivered to the magnet 58 by referring to the origin, and the movement of the back panel 20 is stopped.

When the back panel 20 stops at the location where the back panel 20 has been delivered to the magnet 58, the rotation movement body 41, which has been retracted at retraction location, again rotates and moves to the location of the dotted line C, and combines the back panel 20 with the front panel 10. When the back panel 20 has been combined with the front panel 10, the locking pin 440, which has been housed in the lock opening and closing mechanism 44, ascends, and the tip of the locking pin 440 is inserted into the insertion hole 14 of the front panel 10. By this operation, the locking is performed to the cassette 1, which has been in the lock OFF state, and the cassette 1 transits to the lock ON state. That is, the back panel 20 and the front panel 10 enter the state in which their separation is impossible. When the cassette 1 has transited to the lock ON state, the locking pin 440 descends, and is housed in the lock opening and closing mechanism 44 again. The section for performing a series of operations for making the locked state of the cassette 1 transit from the lock OFF state to the lock ON state in such a way is generically named as a combination section.

When the combination operation of the back panel 20 and the front panel 10 has been completed by the combination section, the rotation movement body 41 again rotates and moves to the location of the dotted line b into the direction of the arrow A6, and stops at the location. Because the operation for peeling off the back panel 20 (cassette 1) from the magnet 58 is performed with the rotation movement, the back panel 20 (cassette 1) can be peeled off from the magnet 58 with the force smaller than that in the case where the back panel 20 is peeled off by a parallel movement. When the rotation movement body 41 stops at the location of the dotted line b, the width pushing sections 42a and 42b move from the holding locations S2 shown in FIGS. 10A and 10B into the direction of the arrows M2, and stop at the retraction locations S1. Thereby, the holding state of the front panel 10 is released, and the apparatus becomes the state in which the cassette 1 can ascend and descend on the rotation movement body 41.

When the holding state of the front panel 10 is released, the elevating base 43 conveys the cassette 1 along the rotation movement body 41 into the direction of the ejection port 4, and delivers the cassette 1 to ejection rollers 73a and 73b. When the ejection rollers 73a and 73b receive the cassette 1, the ejection rollers 73a and 73b perform the ejection operation until the cassette 1 has been completely ejected to the ejection port 4. When the cassette 1 has been completely ejected to the ejection port 4, the rotation movement body 41 rotates and moves to the location of the dotted line a into the direction of the arrow A6, and stops at the location. Then, the rotation movement body 41 transits to the state capable of receiving the next cassette 1.

The present embodiment includes a stacker portion capable of stacking about two to five cassettes 1 at the ejection port 4. When the location of the cassette 1 immediately after the completion of the ejection to the ejection port 4 is denoted by a reference numeral 1a in FIG. 6, the cassette 1, which has been ejected to the location 1a, falls down from the upper end of the cassette 1 into the direction of an arrow A8 owing to the dead weight of the cassette 1, and finally the cassette 1 moves to a location denoted by a reference numeral 1b. In order that the operation may be performed only by the dead weight of the cassette 1, a bottom plate portion 71c of the ejection port 4 is previously inclined from the 1a side to the 1b side. The bottom plate portion 71c is molded out of resin parts, and the surface thereof has a rib shape for reducing the frictional resistance with the cassette 1. Moreover, for preventing the lowering of the sliding property owing to the shaving of the rib shape by the friction with the cassette 1, Teflon coating is performed.

Moreover, in order that the cassette 1 is surely conveyed from the 1a side to the 1b side, the cassette insertion and ejection portion 70 may be configured as follows. For example, an ejected cassette conveying mechanism for conveying the lower part of the cassette 1 into the direction of the arrow A8 is provided to move the whole cassette 1 surely from the location 1a to the location 1b. The ejected cassette conveying mechanism can be realized by adopting a belt conveyance system, a roller conveyance system or the like. Moreover, a mechanism for pushing out the cassette 1 from the 1a side to the 1b side by a not shown mechanism may be adopted. Basically, as long as the consideration for preventing the exits of the ejection rollers 73a and 73b from being covered by the cassette 1 ejected from the ejection port 4 is made, any forms and any positional relations of the cassette 1 ejected from the ejection rollers 73a and 73b may be taken in the stacker portion of the ejection port 4.

Because the ejection port 4 is configured to be able to stack about two to five ejected cassettes 1 (hereinafter the cassette 1 ejected from the ejection port 4 is suitably referred to as an ejected cassette 1), a user can sequentially insert the radiographed cassettes 1 into the insertion opening 3 until the ejection port 4 is filled with the ejected cassettes 1 without removing the ejected cassettes 1. One to five cassettes 1, 1.8 cassettes 1 in average, are generally used at one time of radiography inspection. Accordingly, by configuring the ejection port 4 to be able to stack about two to five ejected cassettes 1, a user is rarely troubled by removing the ejected cassettes 1 during inspection, and can perform the operations efficiently.

When the next cassette 1 is ejected from the ejection port 4 in the case where the stacker portion of the ejection port 4 is filled with the ejected cassettes 1, the following defects are generated: an ejected cassette 1 stacked in the ejection port 4 already is pushed out by the newly ejected cassette 1 to fall, and a trial of ejecting the cassette 1 by force cause a fault. Accordingly, a not shown sensor or a mechanism for detecting whether or not the stacker portion of the ejection port 4 is filled with the ejected cassettes 1 is provided, and whether or not the stacker portion of the ejection port 4 is filled with the ejected cassettes 1 is thereby detected.

In the present embodiment, whether or not the stacker portion is filled with the ejected cassettes 1 is detected by means of an ejection shutter 75, which is located at the upper part of the ejection rollers 73a and 73b and is used with the object of the light shielding of the leaked light from gaps of the ejection rollers 73a and 73b. That is, an ejection shutter open and close detection section (not shown), which judges that the stacker portion is not filled when the ejection shutter 75 has closed after an ejection of the cassette 1 and judges that the stacker portion is filled when the ejection shutter 75 has not closed after an ejection of the cassette 1, is provided, and a not shown control unit detects the fullness of the stacker portion on the basis of a detection signal from the ejection shutter open and close detection section. For performing the control, the ejection shutter 75 is configured not to close completely when the cassette 1 which fills the stacker portion is ejected. Because only by the opening and closing of the ejection shutter 75, the fullness of the stacker portion can be detected as described above, the apparatus can be built in a simple configuration.

When the stacker portion of the ejection port 4 is filled with the ejected cassettes 1, it is preferable to avoid the defect by the following means.

1) Making it impossible to insert any cassettes 1 into the insertion opening 3.

2) Making it possible to insert a cassette 1 into the insertion opening 3, but not taking the cassette 1 to the inside of the apparatus main body 2.

3) Taking the cassette 1 inserted into the insertion opening 3 to the inside of the apparatus main body 2, but stopping the taken cassette 1 before the reading of image information.

4) Taking the cassette 1 inserted into the insertion opening 3 to the inside of the apparatus main body 2 and reading image information, after that, stopping the cassette 1 before ejecting the cassette 1 to the ejection port 4.

Moreover, it is preferable to transmit to a user the information of the fact that the stacker portion of the ejection port 4 is filled with the ejected cassettes 1 by the following means in addition of the above-mentioned means.

1) Transmitting the information to the user by displaying a warning error message on the display section 81, by making an ejection indicator 77 be blinking, or by generating an alarm.

2) Transmitting the information to the user by displaying a message on the display section 81, a monitor of a not shown operation terminal connected to the apparatus main body 2, or the like.

3) Transmitting the information to the user by providing a lid (not shown) in the insertion opening 3, and by making it impossible to insert the cassette 1 owing to the closing of the lid.

It is preferable that, when the user removes a part or the whole of the ejected cassettes 1 to make the stacker portion of the ejection port 4 be in the state of being not filled, the processing of the cassette 1 which has stopped in the apparatus main body 2 or at the insertion opening 3 is automatically resumed.

Moreover, the case where some defects are generated during the following operations and the operation cannot continue can be considered: during the operation of taking the cassette 1 into the apparatus main body 2, during the conveying operation after taking the cassette 1 into the apparatus main body 2, during a read operation, during the operation of ejecting the cassette 1 from the apparatus main body 2, and the like. Various defects can be generated, such as a defect is generated in the conveying section 40 during the conveying operation of the cassette 1 to make it impossible to continue the conveying operation; the back panel 20 or the front panel 10 falls at the time of the delivery of the back panel 20 to the sub-scanning section 50; the front panel 10 and the back panel 20 cannot be separated from each other; and the front panel 10 and the back panel 20 cannot be combined with each other.

When such defects are generated, it is preferable to transmit the generation of the defects to a user by means similar to the means of transmitting the fullness of the stacker portion of the ejection port 4 with the ejected cassettes 1 to the user.

Moreover, when an error is generated in the state capable of ejecting the cassette 1 after conveying the cassette 1 to the inside of the apparatus main body 2, it is preferable to eject the cassette 1 to the ejection port 4 instead of ejecting the cassette 1 to the insertion opening 3. The reason is that, after the cassette 1 has been conveyed into the inside of the apparatus main body 2, a user may try to insert the next cassette 1 into the insertion opening 3.

Moreover, whether or not the next cassette 1 is inserted into the insertion opening 3 is examined with the cassette detection sensor 701, and then the cassette 1 may be ejected into the insertion opening 3 in the case where the cassette 1 is not detected in the insertion opening 3.

Moreover, the eject destination of the cassette 1 may be altered depending the progress of the processing. That is, in the case where an error is generated before the reading of image information, the cassette 1 is ejected into the insertion opening 3; in the case where an error is generated during the reading of image information or after the reading, the cassette 1 is ejected into the ejection port 4; or the like. Moreover, instead of ejecting the cassette 1, the operation of the apparatus may be stopped with the cassette 1 being stopped in the apparatus.

Moreover, it is preferable that, when an error has been generated, the information for specifying the cassette 1 in which the error has been generated, such as the identification number (ID number) of the photostimulable phosphor sheet 28 stored in the code storage element 200, is displayed on the display section 81 or the monitor of a not shown operation terminal connected to the apparatus main body 2 together with the error message, and that the user can discriminate the cassette 1 in which the error has been generated.

In particular, it is preferable that, in the case where the cassette 1 in which the error has been generated is ejected into the insertion opening 3 or the ejection port 4, the information for specifying the cassette 1 in which the error has been generated or an error message indicating the contents of the error are transmitted to a user.

Moreover, in the case where the cassette 1 is not ejected and the operation of the apparatus is stopped with the cassette 1 being stayed in the apparatus at the time of the generation of an error, by displaying the location in the apparatus where the cassette 1 (or the back panel 20, the front panel 10 and the like) is stopped on the display section 81, a not shown operation terminal or the like in the form of the illustration of a cartoon picture, or by displaying an instruction message indicating an operation procedure for taking the cassette 1 (the back panel 20, the front panel 10 or the like) which has stopped in the apparatus, the cassette 1 (or the back panel 20, the front panel 10 and the like) which has stopped in the apparatus can be taken out in a short time.

Moreover, when an error is generated in the state in which the cassette 1 cannot be ejected to the outside, or when the control of stopping the cassette in the apparatus, the operation of the apparatus is stopped, and the generation of the error is notified to the user with the cassette 1 being left in the apparatus. At this time, it is preferable to notify the user of the staying of the cassette in the apparatus, and of the fact that the cassette should be removed together with the error message. In such a way, it is preferable to display an action which the user should perform to the error as a message together with the error information.

As errors which could be generated other than the errors pertaining to the cassette 1 and the apparatus mechanism, electric errors, software errors, communication errors, optical errors and the like can be considered. Even when those errors are generated, it is preferable to notify a user of the contents of the errors as an error message.

In the case of an apparatus used in a medical site, when an apparatus is stopped owing to a defect, it is preferable to restore the apparatus in order to enable the apparatus to be used again by settling the defect immediately as well as by transmitting the generation of the defect to the user.

However, in the conventional radiographic image reading apparatus using a photostimulable phosphor, such a restoring operation from a defect has been limited only to the operation by a service man. Consequently, when a defect is generated, a user is obliged to call up a service man and to stop any radiography services until the service man arrives.

In a copying machine, a printer and the like, when output paper causes a jam, it is common sense that a user maintenance mechanism by which a user can release the jam is mounted. In a radiographic image reading apparatus using a photostimulable phosphor, such a user maintenance mechanism has not been realized. The following reasons are considerable as this situation.

1) In the case of the copying machine or the printer, the output paper is very cheap. Consequently, a premise in which the output paper causing the jam may be destroyed is established (re-output may be performed). However, because the photostimulable phosphor sheet is very expensive in the radiographic image reading apparatus using the photostimulable phosphor, the premise in which the photostimulable phosphor sheet may be destroyed is not established. Owing to such limitation, it is difficult to build a mechanism for user maintenance.

2) In the case of a copying machine or a printer, even if the output paper causing a jam is destroyed, copying or printing out can be performed again. On the other hand, in the photostimulable phosphor sheet used by a radiographic image reading apparatus, the image information of a patient is accumulated. In the case where the photostimulable phosphor sheet is destroyed, it is necessary to perform the re-radiography of the patient, but this is very bad because the patient is exposed to excessive radioactive rays.

Accordingly, in the present embodiment, the user maintenance mechanism, chiefly cassette jam releasing mechanism, of a radiographic image reading apparatus was realized as follows.

As shown in FIG. 6, the apparatus main body 2 is provided with the opening and closing door 5, and by opening the opening and closing door 5, a user can access the inside of the apparatus main body 2. Moreover, the rotation movement body 41 can be manually rotated and moved up to the location of a dotted line d, and consequently, the user can access the inner side (the side of the sub-scanning section 50) than that of the rotation movement body 41. The mechanism is described by using FIGS. 6 and 7. The user manually unfastens a door locking 510 to make the opening and closing door 5 be in its opened state. When the opening and closing door 5 is in its closed state, an interlock killer 530 fixed to the opening and closing door 5 is operating on an interlock switch 96 fixed on the side of the main body of the apparatus, and the apparatus main body 2 is in a situation in which the apparatus main body 2 can operate. But, when the opening and closing door 5 becomes its opened state, the interlock killer 530 slips out from the interlock switch 96, and the interlock operates. Then, the supply of the power source chiefly to a mechanical drive system such as a motor and a sensor, a laser drive system and a high voltage power source system to the photomultiplier is deenergized.

A rotation knob 49 is housed in a housing box 521 in the inside of the opening and closing door 5. The user takes out the rotation knob 49 from the housing box 521, and fits a fitting hole 493 of a disk 492 of the rotation knob 49 to a projection 463 of a cylinder member 462 attached to a motor shaft 461 of the conveyance motor unit 46.

Next, when the user pinches a rotation handle 490 of the rotation knob 49 and clockwise rotates the rotation knob 49, the pinion gear 47 rotates on the irregularly shaped rack teeth 480 formed on the arc of the rotation supporting plate 48, and the rotation movement body 41 performs a rotation movement into the direction of the dotted line d. When the rotation movement body 41 has performed the rotation movement to the location of the dotted line d, a space through which the user can access the inside of the apparatus main body 2 is produced. Consequently, the user can take out the cassette 1 staying in the apparatus main body 2 with both hands.

Incidentally, when the rotation knob 49 is not correctly housed in the housing box 521, a housing confirmation member 520 enters between the opening and closing door 5 and the apparatus main body, and a mechanism is formed so that the opening and closing door 5 is not closed. By the mechanism, the apparatus does not operate in the state in which the rotation knob 49 is fitted to the projection 463 of the cylinder member 462. Consequently, there is no apprehension that torque fluctuations are generated during the rotation of the motor shaft 461, or that the rotation knob 49 gets out of place in the apparatus during the operation to damage the apparatus.

In many cases, the cassette 1 staying in the apparatus main body 2 is chiefly in the form of combining the front panel 10 with the back panel 20 on the elevating base 43. In this case, it is possible to draw out the cassette 1 along the rotation movement body 41 immediately. In this case, because the photostimulable phosphor sheet 28 is protected in the cassette 1, a cassette jam can be released without damaging the photostimulable phosphor sheet 28.

As another case, there is a case where the back panel 20 is located on the magnet 58 and the front panel 10 is located on the rotation movement body 41. In this case, it is possible to tear off the back panel 20 from the magnet 58, and to lay the back panel 20 on top of the front panel 10 located on the rotation movement body 41 at a proper location. After that, both of the front panel 10 and the back panel 20 can be drawn out along the rotation movement body 41. Because the back panel 20 is absorbed to the magnet 58 only by the magnetic force, the back panel 20 can be easily peeled off from the magnet 58 without performing superfluous operations. Moreover, the sub-scanning moving plate 57 of the sub-scanning section 50 is configured to be able to ascend and to descend manually, the sub-scanning moving plate 57 can be manually operated to the location where the back panel 20 is easily peeled off from the magnet 58. This case is characterized in that the state in which no mechanisms contact with the surface of the photostimulable phosphor sheet 28 on the back panel 20 can be kept, and the cassette jam can be released without damaging the surface of the photostimulable phosphor sheet 28.

As another case, there is a case where the front panel 10 is ejected in the ejection port 4 and only the back panel 20 is remaining on the magnet 58. In this case, the back panel 20 is torn off the magnet 58, and is carefully taken out to the outside of the apparatus. This case is also characterized in that the state in which no mechanisms contact with the surface of the photostimulable phosphor sheet 28 on the back panel 20 can be kept, and the cassette jam can be released without damaging the surface of the photostimulable phosphor sheet 28.

Moreover, even in the case where the cassette 1, the front panel 10 and the back panel 20 have fallen in the apparatus main body 2, the fallen cassette 1, the front panel 10 and the back panel 20 can be picked out by performing the rotation movement of the rotation movement body 41 into the direction of the dotted line d.

The locations of the elevating base 43 and the width pushing sections 42a and 42b can be manually altered. Consequently, in the case where the upper part of the cassette 1 interferes with the insertion rollers 72a and 72b, the ejection rollers 73a and 73b, and the mechanisms in the apparatus, and then the rotation movement body 41 cannot perform the rotation movement into the direction of the dotted line d, the elevating base 43 can be manually moved into the direction (downward) of the arrow A2, or the width pushing sections 42a and 42b can be manually moved into the direction of the arrow M2 of FIGS. 10A and 10B. Thereby, the cassette 1 of which the user caused a defect can be taken out from the apparatus without using a special jig.

Moreover, a feature of this apparatus is that the mechanism of the apparatus has no parts which grip or hold the cassette 1, the front panel 10 and the back panel 20 with strong force to the degree at which the above-mentioned parts cannot be manually taken out. Although the insertion rollers 72a and 72b and the ejection rollers 73a and 73b grip the cassette 1, the insertion rollers 72a and 72b the ejection rollers 73a and 73b rotate in a free state. Consequently, the cassette 1 can be easily taken out. Moreover, because there are no parts at which the width pushing sections 42a and 42b fit to the cassette 1 (because the state in which the width pushing sections 42a and 42b only press the cassette 1 from both sides), the cassette 1 can be simply taken out, even in the case of the state in which the cassette 1 is held in the apparatus main body 2 by the width pushing sections 42a and 42b. Moreover, because the width pushing sections 42a and 42b can be manually moved into the direction of the arrow M2 in FIGS. 10A and 10B, the cassette 1 can be taken out after being made to a free state on the elevating base 43.

Moreover, when the cassette 1 is made to stay to stop in the apparatus main body 2 at the time of error generation, the rotation movement body 41 is moved to the location of the dotted line a, and the width pushing sections 42a and 42b are moved to the location of the retraction location S1. After that, the apparatus is stopped, and an error display is performed on the display section 81. Then, the time when the user takes out the cassette 1 can be made to the minimum.

Moreover, also in the case where the back panel 20 is located on the magnet 58, the sub-scanning moving plate 57 is made to descend to the delivery location with the front panel 10 to stop the apparatus, and the time when the user takes out the cassette 1 can be minimized.

One of the important errors which can occur in the present embodiment is an error of leaving the back panel 20 in the apparatus main body 2 and of ejecting only the front panel 10 (fall error of the back panel 20). This is a defect caused by the falling of the back panel by mistake at the time of the combination operations of the front panel 10 and the back panel 20. Even if the defect is generated, because there is no way for confirming the successful combination after the combination operation of the front panel 10 and the back panel 20, the front panel 10 is ejected with the back panel 20 being left in the apparatus main body 2. After this, when the next cassette 1 has been taken to the inside of the apparatus and a series of operations has begun, not only the back panel 20 having falling in the apparatus is destroyed, but also the mechanism of the apparatus is damaged. Accordingly, the present embodiment solved the problem as follows.

First, as shown in FIG. 7, the ejection roller 73b is formed in the shape of a ball roller in order that a space may be formed at the center portion of the ejection roller 73b, and a back panel fall detection mechanism is formed in the space. The back panel fall detection mechanism is comprises a back panel tracing rod 73b1 and a back panel fall detection sensor 73b2. At the time of the state in which the cassette 1 has not passed through the ejection roller 73b, the back panel fall detection sensor 73b2 outputs an ON signal. When the front panel 10 with the back panel 20 has passed through the ejection roller 73b, the tip of the back panel tracing rod 73b1 on the side of the ejection port 4 inclines upward, and the back panel fall detection sensor 73b2 outputs an OFF signal. When the cassette 1 has passed through the ejection roller 73b, the back panel fall detection sensor 73b2 again outputs the ON signal. That is, in the case where the front panel 10 with back panel 20 passes through the ejection roller 73b, the back panel fall detection sensor 73b2 always continues to output the OFF signal during the front panel 10 is passing through.

However, when the front panel 10 without the back panel 20 passes through the ejection roller 73b, the tip of the back panel tracing rod 73b1 on the side of the ejection port 4 once inclines upward when the part of the frame 11 of the front panel 10 passes through. At this time, the back panel fall detection sensor 73b2 outputs the OFF signal. However, after that, because the back panel 20 does not exist, the back panel fall detection sensor 73b2 again outputs the ON signal. That is, the back panel fall detection sensor 73b2 always continues to output the ON signal during the front panel 10 is passing through except the short period during which the part of the frame 11 of the front panel 10 passes through. By capturing the ON signal, the not shown control unit can recognize that the back panel 20 is remaining in the apparatus main body 2. Consequently, the control unit can control the apparatus not to operate even if the next cassette 1 is inserted.

That is, by inspecting the thickness of the cassette 1, the existence or the nonexistence of the back panel 20 is detected. When the thickness of the cassette 1 is smaller than a reference value, the control unit considers that the back panel 20 does not exist (the back panel 20 has fallen), and the control unit can control the apparatus not to operate even if the next cassette 1 is inserted.

Moreover, by the configuration such that the location of the cassette insertion and ejection portion 70 can be easily altered by hand (for example, the configuration in which the location of the cassette insertion and ejection portion 70 is manually slid or moved while rotating toward the upper part direction, or the configuration in which the cassette insertion and ejection portion 70 rotates to move into the horizontal direction like a door, or the configuration capable of easy dismounting), the space for accessing the inside of the apparatus is widened, and maintenance operations become easier to perform.

The conveying section 40 in the embodiment shown in FIG. 6 includes at least two kinds of conveying sections of linear conveying sections by the elevating base 43 (sections for linearly conveying the cassette 1 in the vertical direction along the rotation movement body 41 of the conveying section 40), and a rotation conveying section for performing the rotation movement of the cassette 1 around the rotation axis 45 as the rotation center.

In FIG. 6, the shown is an example realizing the two conveying sections of the linear conveying section and the rotation conveying section on the rotation movement body 41. For example, the two conveying sections of the linear conveying section and the rotation conveying section may be realized by separate mechanisms. For example, the linear conveying section may be configured to perform a rotation movement separately from the rotation conveying section.

Moreover, the rotation conveying section may be configured so that a part of the conveying section 40 (rotation movement body 41) performs the rotation movement.

Moreover, the rotation conveying section may be configured by being divided into a plurality of rotation conveying sections.

Similarly, the linear conveying section may be configured by being divided into a plurality of linear conveying sections.

Moreover, the embodiment shown in FIG. 6 is configured in order that, after the back panel back face 210 of the back panel 20 is absorbed by the magnet 58, the front panel 10 and the back panel 20 are separated from each other. However, a configuration in which the back panel back face 210 of the back panel 20 is absorbed by the magnet 58 after the front panel 10 and the back panel 20 have been separated from each other is adoptable.

Moreover, the embodiment of FIG. 6 is configured in order that, after the cassette 1 is rotated to move, the front panel 10 and the back panel 20 are separated from each other. However, the configuration may be such that only the back panel 20 performs the rotation movement after the separation of the front panel 10 and the back panel 20 from each other.

Moreover, the embodiment of FIG. 6 is configured so that by the rotation movement of the rotation movement body 41, the back panel 20 is delivered to the sub-scanning section 50, but the configuration for delivering the back panel 20 to the sub-scanning section 50 by the rotation movement of a part or the whole of the sub-scanning moving plate 57 may be adopted.

Moreover, in the embodiment of FIG. 6, the conveying section 40 and the sub-scanning function 50 are built on the same substrate 92 and the substrate 92 is fixed to the bottom plate 91 with the vibration-proof rubbers 93 between them. However, the conveying section 40 and the sub-scanning function 50 may be built on the different substrates, and each substrate may be fixed to the bottom plate 91 with the vibration-proof rubbers 93 put therebetween, and further the conveying section 40 may be directly built on the bottom plate 91 without vibration proof. Thereby, the propagation of the vibrations generated by the operation of the conveying section 40 to the sub-scanning section 50 can be prevented.

Moreover, the embodiment of FIG. 6 may be configured so that the back panel 20 is absorbed by the sub-scanning moving plate 57 on which an absorption section such as vacuum is disposed. In this case, the back face of the back panel back face 210 is not required to be a magnetic substance, and the magnet 58 on the sub-scanning moving plate 57 is also unnecessary.

Moreover, the embodiment of FIG. 6 may adopt a structure in which only any one of the insertion opening 3 and the ejection port 4 of the cassette insertion and ejection portion 70 is dismountable from the apparatus main body 2, or a structure in which the location of the cassette insertion and ejection portion 70 can be manually altered. Moreover, the embodiment may adopt a structure in which the insertion opening 3 and the ejection port 4 of the cassette insertion and ejection portion 70 are separately dismountable, or a structure in which the location of the cassette insertion and ejection portion 70 can be separately manually altered.

### INDUSTRIAL APPLICABILITY

As described above, the radiographic image reading apparatus of the present invention is configured to comprise at least two modes of a read mode and a erase mode, and to comprise a switching section for switching at least two modes on the main body of the radiographic image reading apparatus. Consequently, a user can select a necessary mode for a short time, and then the operating efficiency is improved.

Moreover, because the radiographic image reading apparatus is configured to detect the disadvantage of a back panel to fall into the apparatus at the time of performing the separation operation and the combination operation of a front panel and a back panel, or at the time of the delivery of the back panel to sub-scanning section by taking a cassette to the inside of the apparatus, the destroying of the back panel and the damaging of the mechanism of the apparatus are not caused, and then the reliability of the apparatus is improved.

1-22. (canceled)

23. A radiographic image reading system including a cassette to record a radiographic image information of an object to be radiographed and an apparatus to read out the radiographic image information, wherein:
the cassette comprises:
a sheet-shaped recording medium having a front member through which the recording medium receives the radiographic image information of the object, and a back member positioned opposite to the front member, wherein the front and back members are relatively attached to each other so as to form an accommodation space in which the sheet-shaped recording medium is accommodated or detached from each other to open the recording medium; and
the apparatus to read out the radiographic image information comprises:
an insertion section to insert the cassette into the apparatus,
a conveying section to convey the cassette within the apparatus,
a separation section to separate the back member from the front member,
a holding section to hold the back member and the recording medium for reading out the radiographic image information,
a scanning section to read out the radiographic image information from the recording medium by relative movement between the recording medium and the scanning section,
a peeling off section to peel off the back member and the recording medium against the holding section,
a combination section to combine the separated front member with the back member and the recording medium again,
wherein the peeling off section peels off the back member and the recording medium against the holding section, after the front member is combined with the back member again by the combination section,
a detection section to detect a misholding of at least one of the back member and the recording medium by the holding section, and
a control section to control the apparatus according to the detection section so as to prevent damage of the apparatus and the cassette.

24. The radiographic image reading system of claim 23, wherein the detection section detects the misholding of at least one of the back member and the recording medium toward the scanning section.

25. The radiographic image reading system of claim 24, wherein the detection section detects the misholding of the back member by detecting an inclination of a tracing rod tracing the back member during the relative movement.

26. The radiographic image reading system of claim 24, the relative movement between the recording medium and the scanning section is prohibited in a case of a detection of the misholding.

27. The radiographic image reading system of claim 23, wherein the detection section detects the misholding of at least one of the back member and the recording medium toward a direction of gravitational force.

28. The radiographic image reading system of claim 23, wherein a combination of the back member and the recording medium with the front member and peeling off the back member and the recording medium against the holding section are prohibited in a case of a detection of the misholding.
